(19) United States
(12) Patent Application Publication
(10) Pub. No.: US 2006/0062898 A1
(43) Pub. Date: Mar. 23, 2006

(54) Method of making a display sheet comprising discontinuous stripe coating

(75) Inventors: Charles M. Rankin JR., Penfield, NY (US); William D. Devine, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/944,493

(22) Filed: Sep. 17, 2004

(51) Int. Cl. B05D 5/12

(52) U.S. Cl. 427/58; 427/402

(57) ABSTRACT

A light-modulating layer formed by providing an electro-optical fluid in the form of parallel, spaced-apart stripes. In one embodiment, the electro-optical material forms a layer of a liquid-crystal material.

### CROSS REFERENCE TO RELATED APPLICATIONS

Reference is made to commonly assigned, co-pending U.S. patent application Ser. No. ______ by Charles M. Rankin et al. (Docket 88360) filed of even date herewith and titled “APPARATUS FOR FORMING DISCONTINUOUS STRIPE COATINGS” and U.S. patent application Ser. No. ______ by Charles M. Rankin et al. (Docket 88361) filed of even date herewith and titled “METHOD OF DISCONTINUOUS STRIPE COATING.”

### FIELD OF THE INVENTION

The present invention relates to the coating of a dispersed electro-optical material such as a liquid-crystal material.

### BACKGROUND OF THE INVENTION

The present invention relates to the use of a die-coating technique to manufacture sheet materials for an electronically addressable display. World patent application PCT/WO 97/04398, entitled “Electronic Book With Multiple Display Pages,” is a thorough recitation of the art of thin, electronically written sheet-display technologies. Disclosed is the assembling of multiple display sheets that are bound into a “book,” each sheet provided with means to individually address each page. The patent recites prior art in forming thin, electronically written pages, including flexible sheets, image-modulating material formed from a bi-stable liquid crystal system, and thin metallic conductor lines on each page.

Various methods of making a polymer dispersed electro-optical material for displays are known. For example, cholesteric, or chiral nematic, compositions have been widely used. An early patent, U.S. Pat. No. 3,578,844, discloses a light-modulating structure suitable for a display device. In this patent, cholesteric liquid crystal material is encapsulated by light penetrable gelatin and gum Arabic capsules that are coated on a screen. The capsules were formed by emulsifying the cholesteric material in a gelatin solution using a blender to form droplets between 10 and 30 microns in diameter. The pH of the emulsion was changed to precipitate a gelatin coating over each droplet of cholesteric material. The gelatin was hardened and the capsules sieved from the solution. The capsules were then coated over a field-carrying surface to provide an electrically switchable image.

U.S. Pat. No. 3,600,060 to Churchill et al. discloses another process for providing cholesteric liquid crystals in a polymer matrix. The patent discloses emulsifying droplets of liquid crystal in a solution having a dissolved film-forming polymer. The patent further discloses coatings or films having droplets of cholesteric liquid crystal material between 1 and 50 microns in diameter. Suitable binders mentioned in the paper include gelatin, gum arabic, and other water-soluble polymers. Churchill et al. disclose that the emulsion can be coated on a substrate, e.g., by means of a draw down applicator to a wet thickness of about 10 mils and air dried at about 25° C. Churchill et al. state that the layers can be dried to touch. In Example 6, cholesteric liquid crystal material is disposed in an aqueous polymer solution, polyvinyl alcohol or gelatin, and heated in a WARING blender to 70° C. by a heating jacket to form a desired emulsion, after which the emulsions were coated onto glass previously coated with tin oxide.

Another technique for providing liquid crystal domains in a coating is disclosed in U.S. Pat. No. 4,673,255. A resin polymer is dissolved into a liquid crystal. The resulting solution is induced into a cavity between two conductors. The resin-polymer phase is separated from the liquid crystal to form microdroplets of the liquid crystal in a polymeric matrix. The phase separation can be thermally induced, solvent induced or polymerization induced to create domains of liquid crystal.

U.S. Pat. No. 6,061,107 reiterates the phase separation technique to form polymer-dispersed liquid crystals found in U.S. Pat. No. 4,673,255. The patent discloses that controlling the shape of domains of liquid crystal material in a polymer binder can improve light scattering properties. The patent discloses the use of temperature, solvent and polymer-induced phase-separation techniques to provide flattened domains of liquid crystal.

Published application EP 1 116 771 A2 to Stephenson et al. discloses, in one embodiment, dispersing a liquid crystal material in an aqueous bath containing a water-soluble binder material such as gelatin, along with a quantity of colloidal particles wherein the colloidal particles limit coalescence. The limited coalescent materials were coated over a substrate and dried, wherein the coated material formed a set of uniform limited-coalescence domains having a plurality of electrically responsive optical states.

The above-mentioned processes require the manufacture of a liquid-crystal display in individual units, on non-flexible substrates, or in a wasteful and environmentally unfriendly manner. For example, U.S. Pat. No. 6,469,757 to Petruchik requires the selective removal of the light-modulating layer for the electrically conductive layer of a liquid crystal display, by the use of skiving stations. This process facilitates making electrical connections to the underlying conductive layer. This process also requires the application of a solvent to soften the light-modulating layer prior to the skiving operation. One disadvantage is that the skived or removed material is wasted, which is particularly undesirable since the light-modulating material can be very expensive. Furthermore, the removed material typically cannot be reused and must, therefore, be disposed of or recycled, as well as the solvent, which can raise environmental concerns. Another disadvantage is the potential for scratching of the conductive layer, typically ITO, which is susceptible to such damage. This results in liquid-crystal displays that are difficult to manufacture or that may be insufficiently economical for wide spread uses.

There is a need, therefore, for an improved coating method for making a liquid-crystal display or other electro-optical display involving the coating of a dispersed electro-optical fluid on a substrate.

### SUMMARY OF THE INVENTION

The need is met according to the present invention by providing a method of making a display element or sheet having a polymer-dispersed electro-optical fluid, a fluid that can either change its optical state in response to an electrical field, which method includes the steps of:

(a) providing a coatable material comprising an electro-optical fluid, having a plurality of optical states responsive to electric fields;

(b) forming spaced-apart stripes of the coatable material on a movable substrate having, on its surface, a first field-carrying layer forming first conductors, wherein the stripes comprise one or more layers at least one of which comprise the electro-optical material and wherein the width of the lateral space between the stripes is relatively narrow compared to the width of the stripes;

The electro-optical fluid can be, for example, a liquid crystal or an electrophoretic material. In a particularly preferred embodiment, the invention relates to the coating of an electro-optical material comprising the steps of:

(a) providing a coatable material comprising a liquid crystal material and a polymeric binder, which material has a plurality of optical states responsive to electric fields; and

(b) forming spaced-apart stripes of the coatable material on a movable substrate having, on its surface, a first field-carrying layer forming first conductors, wherein the stripes comprise at least two stacked layers at least one of which striped layers comprise the electro-optical material and at least one of which striped layers comprise a functional material, wherein the width of the lateral space between the stripes is relatively narrow compared to the width of the stripes.

In one further embodiment, the method of the invention can further comprise (i) coating a second field-carrying layer over (not necessarily directly) the electro-optical fluid to form second conductors, (ii) optionally coating a dielectric material above the second conductors, and (iii) subsequent to forming the second conductors, depositing a plurality of tracers that connect the second conductors to contact points located in the space between stripes. Subsequent manufacturing operations can include cutting the stripes perpendicular to their longitudinal direction to form individual sheets of display/sensor elements; and cutting the coated web in the longitudinal direction to form strips each containing a single strip and at least a portion of at least one space between stripes. In one preferred embodiment, the electro-optical material is an emulsion having cholesteric liquid crystal material in a gelatin solution, wherein the emulsion is heated to reduce the viscosity of the emulsion prior to coating and the heated emulsion is coating on a substrate by using a method described herein.

### BRIEF DESCRIPTION OF THE DRAWINGS

FIG. 1A is a perspective partial cross-sectional view of one embodiment of a pixilated display that can be manufactured in accordance with the present invention, in which a polymer-dispersed liquid crystal-material is used;

FIG. 1B is a perspective partial cross-sectional view of one embodiment of a segmented display that can be manufactured in accordance with the present invention, in which a polymer-dispersed liquid crystal-material is used;

FIG. 2 is an array of display elements having a common flexible substrate in accordance with the prior art;

FIG. 3 is top view of a continuous common substrate having a plurality of display elements formed in association with a three-stripe coating during the manufacture of a pixilated display as in FIG. 1A in accordance with the present invention;

FIG. 4 is a top view of an alternate embodiment of the method of the present invention showing a continuous common substrate having a plurality of display elements formed in association with a two-stripe coating in accordance with the present invention, wherein each of the exposed longitudinal areas, between striped layers of cholesteric material, form unexposed conductors for both of the adjacent rows of display elements in adjacent stripes;

FIG. 5 is a magnified extended top view of a display element shown diagrammatically in FIG. 3 but showing the greater number of first electrodes commonly used during the manufacture of a pixilated display;

FIG. 6 is a side view of the display element taken through section 6-6 of FIG. 3 showing a substrate as a portion of common substrate having selectively stripe coated material over first conductors;

FIG. 7 is a top view of the display element of FIG. 3 with printed second conductors over the striped coatings;

FIG. 8 is a bounded side view of the display element with printed second conductors having electrically addressable pixels, which side view is taken through section 8-8 of FIG. 7;

FIG. 9 is an extended front (bottom) view of the display element of FIG. 7 showing the electrically addressable pixels in bolder line;

FIG. 10 is a rear view of a sheet made in accordance with the present invention during the manufacture of a segmented display as in FIG. 1B showing a patterned first conductor;

FIG. 11 is a rear view of a display in which second conductors and a dielectric layer are shown during the manufacture of the segmented display;

FIG. 12 is a front view of the segmented display of FIG. 11 in accordance with the method of the present invention as seen through the transparent support;

FIG. 13 is a top plan view of the display sheet of FIG. 12 after application of third conductors or traces in accordance with the one embodiment of the present invention;

FIG. 14 is a schematic, partially sectional view of one embodiment of a coating apparatus that can be used to produce flexible sheets of a polymer-dispersed electro-optical fluid according to the invention;

FIG. 15 is a partially sectional view of the lower die element and associated guide shim of the die set shown in FIG. 14;

FIG. 16 is a top view of the middle die element and associated guide shim of the die set-shown in FIG. 14;

FIG. 17 is a diagrammatical side cross-sectional view of the a portion of the die set of FIG. 14 showing the formation of the coated layer; and

FIG. 18 is a schematic, partially sectional view of another embodiment of a coating apparatus used to produce flexible sheets on which is coated three stacked layers in stripes according to the invention;

### DETAILED DESCRIPTION OF THE INVENTION

The present invention relates to a method of manufacturing a display comprising a substrate or support, a patterned conductor, and an electro-optical material having electrically writable areas. A method is disclosed for coating of an electro-optical material such a liquid-crystal materials, although other electro-optical materials can be used in the present method. In the present method, a coated sheet can be formed using inexpensive, efficient layering methods. A single large volume of sheet material can be coated on a moving flexible web and later formed into smaller sheets corresponding to individual display components or elements for use in display devices such as transaction cards, signage, labels, and the like. Displays in the form of sheets in accordance with the present invention are inexpensive, simple, and fabricated using low-cost processes. In a preferred embodiment of this invention, the flexible web is only coated where needed by the use of a die set that restricts the flow of coating material to form stripes. The die set comprises guide shims that can be made of metal or plastic materials, preferably stainless steel. The stripes form longitudinal rows of potential individual displays as will be described in greater detail below.

The support bears an electrically modulated imaging layer over at least one surface. As used herein, the terms “over,” “above,” “on,” “under,” “top,” “bottom,” and the like, of the layers in the display element, refer to the order of the layers over the support, but do not necessarily indicate that the layers are immediately adjacent or that there are no intermediate layers. The term “front,” “upper,” and the like refer to the side of the display element closer to the side being viewed during use. In describing the embodiments of the invention herein, a bottom coated layer is closer to the front of the display, relatively speaking, compared to a top layer which is closer to the back of the display.

The “electro-optical” material is a “light-modulating material” that, as used herein, includes electrically modulated materials. Optionally, such materials may also function as thermo-chromic materials. A thermo-chromic material is capable of changing its state alternately between transparent and opaque upon the application of heat. In this manner, a thermo-chromic imaging material develops images through the application of heat at specific pixel locations in order to form an image. The thermo-chromic imaging material retains a particular image until heat is again applied to the material.

The light-modulated material may also include surface stabilized ferroelectric liquid crystals (SSFLC). Surface stabilized ferroelectric liquid crystals confining ferroelectric liquid crystal material between closely-spaced plates to suppress the natural helix configuration of the crystals. The cells switch rapidly between two optically distinct, stable states simply by alternating the sign of an applied electric field.

Those skilled in the art will recognize that a variety of bi-stable non-volatile imaging materials are available and may also be used in the present invention. The light-modulating material employed in connection with the present invention preferably has the characteristic that it does not require power to maintain display of indicia.

The light-modulating material may also be configured as a single color, such as black, white or clear, and may be fluorescent, iridescent, bioluminescent, incandescent, ultraviolet, infrared, or may include a wavelength specific radiation absorbing or emitting material. There may be multiple layers of light-modulating material. Different layers or regions of the electrically modulated material may have different properties or colors. Moreover, the characteristics of the various layers may be different from each other. For example, one layer can be used to view or display information in the visible light range, while a second layer responds to or emits ultraviolet light.

The preferred light-modulating material for an imaging layer comprises a liquid crystalline material. Liquid crystals can be nematic (N), chiral nematic (N*), or smectic, depending upon the arrangement of the molecules in the mesophase. Chiral nematic liquid crystal (N*LC) displays are typically reflective, that is, no backlight is needed, and can function without the use of polarizing films or a color filter.

Chiral-nematic liquid crystal refers to the type of liquid crystal having finer pitch than that of twisted nematic and super-twisted nematic used in commonly encountered LC devices. Chiral-nematic liquid crystals are so named because such liquid crystal formulations are commonly obtained by adding chiral agents to host nematic liquid crystals. Chiral-nematic liquid crystals may be used to produce bi-stable or multi-stable displays. These devices have significantly reduced power consumption due to their non-volatile “memory” characteristic. Since such displays do not require a continuous driving circuit to maintain an image, they consume significantly reduced power. Chiral-nematic displays are bistable in the absence of a field; the two stable textures are the reflective planar texture and the weakly scattering focal conic texture.

In the planar texture, the helical axes of the chiral-nematic liquid crystal molecules are substantially perpendicular to the substrate upon which the liquid crystal is disposed. In the focal-conic state the helical axes of the liquid crystal molecules are generally randomly oriented. Adjusting the concentration of chiral dopants in the chiral-nematic material modulates the pitch length of the mesophase and, thus, the wavelength of radiation reflected. Chiral-nematic materials that reflect infrared radiation and ultraviolet have been used for purposes of scientific study. Commercial displays are most often fabricated from chiral-nematic materials that reflect visible light. Some known LCD devices include chemically etched, transparent, conductive layers overlying a glass substrate as described in U.S. Pat. No. 5,667,853, incorporated herein by reference.

In one preferred embodiment, a chiral-nematic liquid crystal composition may be dispersed in a continuous matrix. Such materials are referred to as “polymer-dispersed liquid crystal” materials or “PDLC” materials. Such materials can be made by a variety of methods. For example, Doane et al. (Applied Physics Letters, 48, 269 (1986)) disclose a PDLC comprising approximately 0.4 mm droplets of nematic liquid crystal 5CB in a polymer binder. A phase separation method is used for preparing the PDLC. A solution containing monomer and liquid crystal is filled-in a display cell and the material is then polymerized. Upon polymerization the liquid crystal becomes immiscible and nucleates to form droplets. West et al. (Applied Physics Letters 63, 1471 (1993)) disclose a PDLC comprising a chiral nematic mixture in a polymer binder. Once again a phase separation method is used for preparing the PDLC. The liquid crystal material and polymer (a hydroxy functionalized polymethylmethacrylate) along with a cross-linker for the polymer are dissolved in a common organic solvent toluene and coated on an indium tin oxide (ITO) substrate. A dispersion of the liquid-crystal material in the polymer binder is formed upon evaporation of toluene at high temperature.

In one particular embodiment of the invention, a liquid crystal material may be applied as a substantial monolayer. The term “substantial monolayer” is defined by the Applicants to mean that, in a direction perpendicular to the plane of the display, there is no more than a single layer of domains sandwiched between the electrodes at most points of the display (or the imaging layer), preferably at 75 percent or more of the points (or area) of the display, most preferably at 90 percent or more of the points (or area) of the display. In other words, at most, only a minor portion (preferably less than 10 percent) of the points (or area) of the display has more than a single domain (two or more domains) between the electrodes in a direction perpendicular to the plane of the display, compared to the amount of points (or area) of the display at which there is only a single domain between the electrodes.

The amount of material needed for a monolayer can be accurately determined by calculation based on individual domain size, assuming a fully closed packed arrangement of domains. (In practice, there may be imperfections in which gaps occur and some unevenness due to overlapping droplets or domains.) On this basis, the calculated amount is preferably less than about 150 percent of the amount needed for monolayer domain coverage, preferably not more than about 125 percent of the amount needed for a monolayer domain coverage, more preferably not more than 110 percent of the amount needed for a monolayer of domains. Furthermore, improved viewing angle and broadband features may be obtained by appropriate choice of differently doped domains based on the geometry of the coated droplet and the Bragg reflection condition.

In a preferred embodiment of the invention, the display device or display sheet has simply a single imaging layer of liquid crystal material along a line perpendicular to the face of the display, preferably a single layer coated on a flexible substrate. Such a structure, as compared to vertically stacked imaging layers each between opposing substrates, is especially advantageous for monochrome shelf labels and the like. Structures having stacked imaging layers, however, are optional for providing additional advantages in some case.

Preferably, the domains are flattened spheres and have on average a thickness substantially less than their length, preferably at least 50% less. More preferably, the domains on average have a thickness (depth) to length ratio of 1:2 to 1:6. The flattening of the domains can be achieved by proper formulation and sufficiently rapid drying of the coating. The domains preferably have an average diameter of 2 to 30 microns. The imaging layer preferably has a thickness of 10 to 150 microns when first coated and 2 to 20 microns when dried.

The flattened domains of liquid crystal material can be defined as having a major axis and a minor axis. In a preferred embodiment of a display or display sheet, the major axis is larger in size than the cell (or imaging layer) thickness for a majority of the domains. Such a dimensional relationship is shown in U.S. Pat. No. 6,061,107, hereby incorporated by reference in its entirety.

Modern chiral-nematic liquid crystal materials usually include at least one nematic host combined with a chiral dopant. In general, the nematic liquid crystal phase is composed of one or more mesogenic components combined to provide useful composite properties. Many such materials are available commercially. The nematic component of the chiral-nematic liquid crystal mixture may be comprised of any suitable nematic liquid crystal mixture or composition having appropriate liquid crystal characteristics. The nematic liquid crystal phases typically consist of 2 to 20, preferably 2 to 15 components. The above list of materials is not intended to be exhaustive or limiting. The lists disclose a variety of representative materials suitable for use or mixtures, which comprise the active element in electro-optic liquid crystal compositions.

Suitable chiral-nematic liquid crystal compositions preferably have a positive dielectric anisotropy and include chiral material in an amount effective to form focal conic and twisted planar textures. Chiral-nematic liquid crystal materials are preferred because of their excellent reflective characteristics, bi-stability and gray scale memory. The chiral-nematic liquid crystal is typically a mixture of nematic liquid crystal and chiral material in an amount sufficient to produce the desired pitch length. Suitable commercial nematic liquid crystals include, for example, E7, E44, E48, E31, E80, BL087, BL101, ZLI-3308, ZLI-3273, ZLI-5048-000, ZLI-5049-100, ZLI-5100-100, ZLI-5800-000, MLC-6041-100.TL202, TL203, TL204 and TL205 manufactured by E. Merck (Darmstadt, Germany). Although nematic liquid crystals having positive dielectric anisotropy, and especially cyanobiphenyls, are preferred, virtually any nematic liquid crystal known in the art, including those having negative dielectric anisotropy should be suitable for use in the invention. Other nematic materials may also be suitable for use in the present invention as would be appreciated by those skilled in the art.

The chiral dopant added to the nematic mixture to induce the helical twisting of the mesophase, thereby allowing reflection of visible light, can be of any useful structural class. The choice of dopant depends upon several characteristics including among others its chemical compatibility with the nematic host, helical twisting power, temperature sensitivity, and light fastness. Many chiral dopant classes are known in the art: e.g., G. Gottarelli and G. Spada, Mol. Cryst. Liq. Crys., 123, 377 (1985); G. Spada and G. Proni, Enantiomer, 3, 301 (1998), U.S. Pat. No. 6,217,792; U.S. Pat. No. 6,099,751; and U.S. patent application Ser. No. 10/651,692, hereby incorporated by reference.

Chiral-nematic liquid crystal materials and cells, as well as polymer stabilized chiral nematic liquid crystals and cells, are well known in the art and described in, for example, U.S. Pat. No. 5,437,811; Yang et al., Appl. Phys. Lett. 60(25) pp 3102-04 (1992); Yang et al., J. Appl. Phys. 76(2) pp 1331 (1994); published International Patent Application No. PCT/US92/09367; and published International Patent Application No. PCT/US92/03504, all of which are incorporated herein by reference.

The liquid crystalline droplets or domains may be formed by any method, known to those of skill in the art, which will allow control of the domain size. Liquid crystal domains are preferably made using a limited coalescence methodology, as disclosed in U.S. Pat. Nos. 6,556,262 and 6,423,368, incorporated herein by reference. Limited coalescence is defined as dispersing a light-modulating material below a given size, and using coalescent limiting material to limit the size of the resulting domains. Such materials are characterized as having a ratio of maximum to minimum domain size of less than 2:1. By use of the term “uniform domains,” it is meant that domains are formed having a domain size variation of less than 2:1. Limited domain materials have improved optical properties.

Suitable polymeric binders for polymer-dispersed liquid crystal materials include both naturally occurring substances such as proteins, protein derivatives, cellulose derivatives (e.g. cellulose esters), gelatins and gelatin derivatives, polysaccaharides, casein, and the like, and synthetic water permeable colloids such as poly(vinyl lactams), acrylamide polymers, poly(vinyl alcohol) and its derivatives, hydrolyzed polyvinyl acetates, polymers of alkyl and sulfoalkyl acrylates and methacrylates, polyamides, polyvinyl pyridine, acrylic acid polymers, maleic anhydride copolymers, polyalkylene oxide, methacrylamide copolymers, polyvinyl oxazolidinones, maleic acid copolymers, vinyl amine copolymers, methacrylic acid copolymers, acryloyloxyalkyl acrylate and methacrylates, vinyl imidazole copolymers, vinyl sulfide copolymers, and homopolymer or copolymers containing styrene sulfonic acid. Gelatin is preferred.

Gelatin, containing hardener, may optionally be used in the present invention. In the context of this invention, hardeners are defined as any additive, which causes chemical crosslinking in gelatin or gelatin derivatives. Many conventional hardeners are known to crosslink gelatin. Gelatin crosslinking agents (i.e., the hardener) are included in an amount of at least about 0.01 wt. % and preferably from about 0.1 to about 10 wt. % based on the weight of the solid dried gelatin material used (by dried gelatin is meant substantially dry gelatin at ambient conditions as for example obtained from Eastman Gel Co., as compared to swollen gelatin), and more preferably in the amount of from about 1 to about 5 percent by weight. More than one gelatin crosslinking agent can be used if desired. Suitable hardeners, both organic and-inorganic are described in commonly assigned, copending U.S. Ser. No. 10/619,329, Filed Jul. 14, 2003, hereby incorporated by reference. Other examples of hardening agents can be found in standard references such as The Theory of the Photographic Process, T. H. James, Macmillan Publishing Co., Inc. (New York 1977) or in Research Disclosure, Sep. 1996, Vol. 389, Part IIB (Hardeners) or in Research Disclosure, Sep. 1994, Vol. 365, Item 36544, Part IIB (Hardeners). Research Disclosure is published by Kenneth Mason Publications, Ltd., Dudley House, 12 North St., Emsworth, Hampshire P010 7DQ, England.

A preferred class of hardeners are compounds comprising two or more vinyl sulfonyl groups. These -compounds are hereinafter referred to as “vinyl sulfones.” Compounds of this type are described in numerous patents including, for example, U.S. Pat. Nos. 3,490,911; 3,642,486; 3,841,872; and 4,171,976. Vinyl sulfone hardeners are believed to be effective as hardeners as a result of their ability to crosslink polymers making up the colloid.

As used herein, the phase a “liquid crystal display” (LCD) is a type of flat panel display used in various electronic devices. At a minimum, an LCD comprises a substrate, at least one conductive layer and a liquid crystal layer. LCDs may also optionally comprise two sheets of polarizing material with a liquid crystal solution between the polarizing sheets. The sheets of polarizing material may comprise a substrate of glass or transparent plastic. The LCD may also include functional layers. In one embodiment of an LCD, a transparent, multilayer flexible support is coated with a first conductive layer, which may be patterned, onto which is coated the light-modulating liquid crystal layer. A second conductive layer is applied and overcoated with a dielectric layer to which dielectric conductive row contacts are attached, including via that permit interconnection between conductive layers and the dielectric conductive row contacts. An optional nanopigmented functional layer may be applied between the liquid crystal layer and the second conductive layer.

A liquid crystal (LC) element can also include an optical switch. The substrates for such devices are usually manufactured with transparent, conductive electrodes, in which electrical “driving” signals are coupled. The driving signals induce an electric field which can cause a phase change or state change in the LC material, the LC exhibiting different light-reflecting characteristics according to its phase and/or state.

An LCD contains at least one conductive layer, which typically is comprised of a primary metal oxide. This conductive layer may comprise other metal oxides such as indium oxide, titanium dioxide, cadmium oxide, gallium indium oxide, niobium pentoxide and tin dioxide. See, Int. Publ. No. WO 99/36261 by Polaroid Corporation. In addition to the primary oxide such as ITO, the at least one conductive layer can also comprise a secondary metal oxide such as an oxide of cerium, titanium, zirconium, hafnium and/or tantalum. See, U.S. Pat. No. 5,667,853 to Fukuyoshi et al. (Toppan Printing Co.) Other transparent conductive oxides include, but are not limited to ZnO₂, Zn₂SnO₄, Cd₂SnO₄, Zn₂In₂O₅, MgIn₂O₄, Ga₂O₃—In₂O₃, or TaO₃. The conductive layer may be formed, for example, by a low temperature sputtering technique or by a direct current sputtering technique, such as DC-sputtering or RF-DC sputtering, depending upon the material or materials of the underlying layer. The conductive layer may be a transparent, electrically conductive layer of tin-oxide or indium-tin-oxide (ITO), or polythiophene, with ITO being the preferred material. Typically, the conductive layer is sputtered onto the substrate to a resistance of less than 250 ohms per square. Alternatively, the conductive layer may be an opaque electrical conductor formed of metal such as copper, aluminum or nickel. If the conductive layer is an opaque metal, the metal can be a metal oxide to create a light absorbing conductive layer.

Indium tin oxide (ITO) is a preferred conductive material, as it is a cost effective conductor with good environmental stability, up to 90% transmission, and down to 20 ohms per square resistivity. An exemplary preferred ITO layer has a % T greater than or equal to 80% in the visible region of light, that is, from greater than 400 nm to 700 nm, so that the film will be useful for display applications. In a preferred embodiment, the conductive layer comprises a layer of low temperature ITO which is polycrystalline. The ITO layer is preferably 10-120 nm in thickness, or; 50-100 nm thick to achieve a resistivity of 20-60 ohms/square on plastic. An exemplary preferred ITO layer is 60-80 nm thick.

The conductive layer is preferably patterned. The conductive layer is preferably patterned into a plurality of electrodes. The patterned electrodes may be used to form a LCD device. In another embodiment, two conductive substrates are positioned facing each other and cholesteric liquid crystals are positioned therebetween to form a device. The patterned ITO conductive layer may have a variety of dimensions. Exemplary dimensions may include line widths of 10 microns, distances between lines, that is, electrode widths, of 200 microns, depth of cut, that is, thickness of ITO conductor, of 100 nanometers. ITO thicknesses on the order of 60, 70, and greater than 100 nanometers are also possible.

The display may also contain a second conductive layer applied to the surface of the light-modulating layer. The second conductive layer desirably has sufficient conductivity to carry a field across the light-modulating layer. The second conductive layer may be formed in a vacuum environment using materials such as aluminum, tin, silver, platinum, carbon, tungsten, molybdenum, or indium. Oxides of these metals can be used to darken patternable conductive layers. The metal material can be excited by energy from resistance heating, cathodic arc, electron beam, sputtering or magnetron excitation. The second conductive layer may comprise coatings of tin-oxide or indium-tin oxide, resulting in the layer being transparent. Alternatively, second conductive layer may be printed conductive ink.

For higher conductivities, the second conductive layer may comprise a silver-based layer which contains silver only or silver containing a different element such as aluminum (Al), copper (Cu), nickel (Ni), cadmium (Cd), gold (Au), zinc (Zn), magnesium (Mg), tin (Sn), indium (In), tantalum (Ta), titanium (Ti), zirconium (Zr), cerium (Ce), silicon (Si), lead (Pb) or palladium (Pd). In a preferred embodiment, the conductive layer comprises at least one of gold, silver and a gold/silver alloy, for example, a layer of silver coated on one or both sides with a thinner layer of gold. See, Int. Publ. No. WO 99/36261 by Polaroid Corporation. In another embodiment, the conductive layer may comprise a layer of silver alloy, for example, a layer of silver coated on one or both sides with a layer of indium cerium oxide (InCeO). See U.S. Pat. No. 5,667,853, incorporated herein in by reference.

The second conductive layer may be patterned irradiating the multi-layered conductor/substrate structure with ultraviolet radiation so that portions of the conductive layer are ablated therefrom. It is also known to employ an infra-red (IR) fiber laser for patterning a metallic conductive layer overlying a plastic film, directly ablating the conductive layer by scanning a pattern over the conductor/film structure. See: Int. Publ. No. WO 99/36261 and “42.2: A New Conductor Structure for Plastic LCD Applications Utilizing ‘All Dry’ Digital Laser Patterning,” 1998 SID International Symposium Digest of Technical Papers, Anaheim, Calif., May 17-22, 1998, no. VOL. 29, May 17, 1998, pages 1099-1101, both incorporated herein by reference.

The LCD may also comprise at least one “functional layer” between the conductive layer and the substrate. The functional layer may, for example, comprise a protective layer or a barrier layer. A preferred barrier layer may act as a gas barrier or a moisture barrier and may comprise SiOx , AlOx or ITO. A protective layer, for example an acrylic hard coat, functions to prevent laser light from penetrating to functional layers between the protective layer and the substrate, thereby protecting both the barrier layer and the substrate. Another example of a type of functional layer is a layer serving as an adhesion promoter of the conductive layer to the substrate.

The polymeric support optionally may comprise an antistatic layer to manage unwanted charge build up on the sheet or web during roll conveyance or sheet finishing. In another embodiment of this invention, the antistatic layer has a surface resistivity of between 105 to 1012. The antistatic layer is separate from the highly conductive layer of ITO and provides the best static control when it is on the opposite side of the web substrate from that of the ITO layer. This may include the web substrate itself.

Another type of functional layer may be a color contrast layer. Color contrast layers may be radiation reflective layers or radiation absorbing layers. In some cases, the rearmost substrate of each display may preferably be painted black. The color contrast layer may also be other colors. In another embodiment, the dark layer comprises milled nonconductive pigments. The materials are milled below 1 micron to form “nano-pigments.” In a preferred embodiment, the dark layer absorbs all wavelengths of light across the visible light spectrum, that is from 400 nanometers to 700 nanometers wavelength. The dark layer may also contain a set or multiple pigment dispersions. Suitable pigments used in the color contrast layer may be any colored materials, which are practically insoluble in the medium in which they are incorporated. Suitable pigments include those described in Industrial Organic Pigments: Production, Properties, Applications by W. Herbst and K. Hunger, 1993, Wiley Publishers. These include, but are not limited to, Azo Pigments such as monoazo yellow and orange, diazo, naphthol, naphthol reds, azo lakes, benzimidazolone, diazo condensation, metal complex, isoindolone and isoindolinic, polycyclic pigments such as phthalocyanine, quinacridone, perylene, perinone, diketopyrrolo-pyrrole, and thioindigo, and anthriquinone pigments such as anthrapyrimidine.

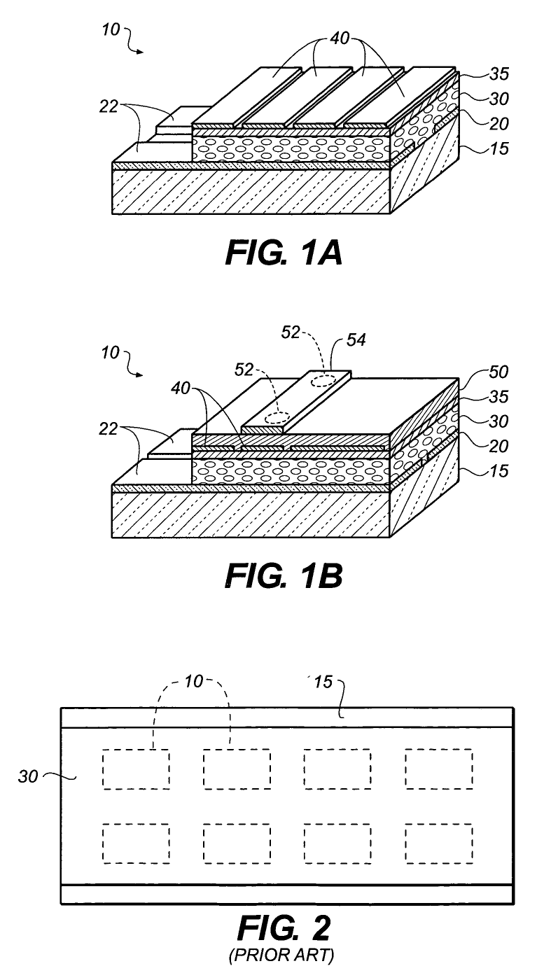

Turning now to the embodiments shown in the figures, FIG. 1A is a partial cross-sectional perspective view of one preferred embodiment of an individual pixilated display comprising that can be made in accordance with the invention, which display employs a liquid-crystal material. For example, a sheet designated as display 10 is made in accordance with the present invention. Display 10 includes a flexible substrate 15, which can be a thin transparent polymeric material, such as Kodak Estar® film base formed of polyester plastic that has a thickness of between 20 and 200 micrometers. In an exemplary embodiment, flexible substrate 15 is a 125-micrometer thick sheet of polyester film base. Other polymers, such as transparent polycarbonate, can also be used.

One or more transparent first conductors 20 are formed on flexible substrate 15. Transparent first conductors 20 can be tin-oxide, indium-tin-oxide (ITO), or polythiophene, with ITO being the preferred material. Typically the material of transparent first conductors 20 is sputtered or coated as a layer over flexible substrate 15 having a resistance of less than 1000 ohms per square. Transparent first conductors 20 can be formed in the conductive layer by conventional lithographic or laser etching means. Transparent first conductors 20 can also be formed by printing a transparent organic conductor such as PEDT/PSS, PEDOT/PSS polymer, which materials are sold as Baytron® P by Bayer AG Electronic Chemicals. Portions of transparent first conductors 20 can be uncoated to provide exposed transparent first conductors 22 for this embodiment.

Cholesteric layer 30 overlays transparent first conductors 20. Cholesteric layer 30 contains cholesteric liquid-crystal material, such as those disclosed in U.S. Pat. No. 5,695,682 to Doane et al., the disclosure of which is incorporated by reference. Such materials are made using highly anisotropic nematic liquid crystal mixtures and adding a chiral doping agent to provide helical twist in the planes of the liquid crystal to the point that interference patterns are created that reflect incident light. Application of electrical fields of various intensity and duration can be employed to drive-a chiral-nematic (cholesteric) material into a reflective state, to near-transparent or transmissive state, or an intermediate state. These materials have the advantage of having first and second optical states that are both stable in the absence of an electrical field. The materials can maintain a given optical state indefinitely after the field is removed. Cholesteric liquid crystal materials can be formed, for example, using a two-component system such as MDA-00-1444 (undoped nematic) and MDA-00-4042 (nematic with high chiral dopant concentrations) available from E.M. Industries of Hawthorne, N.Y.

In a preferred embodiment, cholesteric layer 30 is a cholesteric material dispersed in photographic gelatin. The liquid crystal material is mixed at 8% cholesteric liquid crystal in a 5% gelatin aqueous solution. The mixture is dispersed to create an emulsion having 8-10 micrometer diameter domains of the liquid crystal in aqueous suspension. The domains can be formed using the limited coalescence technique described in U.S. Pat. No. 6,423,368 by Stephenson et al. The emulsion is coated over transparent first conductors 20 on a polyester flexible substrate 15 and dried to provide an approximately 9-micrometer thick polymer dispersed cholesteric coating. Other organic binders such as polyvinyl alcohol (PVA) or polyethylene oxide (PEO) can be used in place of the gelatin. Such emulsions are machine coatable using coating equipment of the type employed in the manufacture of photographic films. A gel sub-layer (not shown in FIG. 1) can optionally be applied over transparent first conductors 20 prior to applying cholesteric layer 30 as disclosed in U.S. Pat. No. 6,423,368 by Stephenson et al., hereby incorporated by reference in its entirety. The gel sub-layer acts a buffer layer to prevent electrical shortages from occurring during display use.

Dark layer 35 overlays cholesteric layer 30. In a preferred embodiment, dark layer 35 is a light-absorbing layer composed of pigments that are milled below 1 micrometer to form “nano-pigments” in a binder. Such pigments are very effective in absorbing wavelengths of light in very thin (sub-micrometer) layers. Such pigments can be selected to be electrically inert to prevent degradation interference from electrical display fields applied to display 10. Such pigments are disclosed in U.S. Pat. No. 6,788,362, hereby incorporated by reference.

In the present embodiment, in FIG. 1, dark layer 35 is coated over cholesteric layer 30 to provide a light-absorbing layer that provides a specific contrast state to reflected light. The coating can be simultaneous with the deposition of cholesteric layer 30 or as a separate step. In a preferred embodiment, the die-coating device of the present method provides cholesteric layer 30 and dark layer 35 as two co-deposited layers. Dark layer 35 is significantly thinner than cholesteric layer 30 and has minimal effect on the electrical field strength required to change the state of the cholesteric liquid-crystal material.

Second conductors 40 overlay dark layer 35. Second conductors 40 have sufficient conductivity to induce an electric field across cholesteric layer 30 strong enough to change the optical state of the polymeric material. Second conductors 40 are preferably formed by vacuum deposition of conductive material such as aluminum, chrome, silver or nickel. The layer of conductive material can be patterned using well-known techniques such as photolithography, laser etching or by application through a mask. In another embodiment, second conductors 40 can be formed by screen printing a reflective and conductive formulation such as UVAG® 0010 from Allied Photochemical of Kimball, Mich. Such screen printable conductive materials comprise finely divided silver in ultraviolet-curable resin. After printing, the material is exposed to ultraviolet radiation greater than 0.40 Joules/cm², the resin will polymerize in 2 seconds to form a durable surface. Screen printing is preferred to minimize the cost of manufacturing the display. Alternatively, second conductors 40 can be formed by screen printing a thermally cured silver-bearing resin. An example of such a material is Acheson Electroda® 461SS, a heat cured silver ink. In the case that the dark layer 35 is black, any type of conductor can be used including black carbon in a binder.

Turning now to FIG. 1B, a segmented display is shown in partial cross-sectional perspective view, which segmented display can be made in accordance with the invention as described below. The structure of the segmented display of FIG. 1B can include the same type of layers as described for the pixilated display of FIG. 1A with additional layers on top. However, the patterns for the first and second conductors for the segmented display in FIG. 1B differ from the pixilated display in FIG. 1A. The pattern for the second conductors in the pixilated display typically comprises numerous parallel bars perpendicular to numerous parallel bars forming the first conductors, whereas the second conductors in the segmented display typically vary in shape and size, for example, as do the segments of alphanumeric characters and the first conductors are each in the form of larger areas (for example, sequential rectangular areas) that are under a plurality of second conductors.

Referring still to the embodiment of FIG. 1B, a dielectric layer 50 is shown over second conductors 40. Dielectric layer 50 is provided with a plurality of “through via holes” 52 that permit interconnection between each second conductor 40 and conductive traces 54. Dielectric layer 50 is formed, for example, by coating, or printing, a vinyl polymer dissolved in a solvent. Third conductors or traces 54 (sometimes referred to as electrical tracers) can be formed by screen printing the same screen-printable, electrically conductive material used to form second conductors 40. The third conductors or traces 54 enable the connection of common segments in different characters, thereby creating functional rows of electrically addressable areas in the polymer-dispersed cholesteric liquid-crystal layer. The third conductors or traces and exposed first conductors 22 form a set of backside display contacts that are used to electrically address the display.

The use of a flexible support for flexible substrate 15; thin transparent first conductors 20; machine-coated cholesteric liquid-crystal layer 30; and printed second conductors 40 permits the fabrication of a low-cost flexible display. Small displays can be used as electronically rewritable tags or labels for inexpensive, rewrite applications.

In a preferred embodiment of a display, the cholesteric material (also referred to as chiral-nematic) can exhibit two stable optical states. For example, it is known that applying a higher voltage-field and quickly switching to zero potential causes such liquid crystal molecules to become planar liquid crystals. On the other hand, application of a lower voltage field causes molecules of the cholesteric liquid crystal to break into transparent tilted cells that are known as focal-conic liquid crystals. Varying electrical field pulses can progressively change the molecular orientation from planar state to a fully evolved and transparent focal conic state.

A thin layer of light-absorbing submicron carbon or a nanopigment in a gel binder can be disposed between second conductors and polymer-dispersed cholesteric layer as disclosed in copending U.S. Ser. No. 10/036,149 filed Dec. 26, 2001 by Stephenson et al., hereby incorporated by reference. Focal-conic liquid crystals are transparent, passing incident light, which is absorbed by second conductors to provide a black image. Progressive evolution from planar to focal-conic state causes a viewer to see an initial bright, reflected light which transitions to black as the cholesteric material changes from planar state to a fully evolved focal-conic state. The transition to the light-transmitting state is progressive, and varying the low-voltage time permits variable levels of reflection. These variable levels can be mapped out to corresponding gray levels, and when the field is removed, polymer dispersed cholesteric layer maintains a given optical state indefinitely. The states are more fully discussed in U.S. Pat. No. 5,437,811.

A process for fabricating display 10 that is pixilated as in FIG. 1A will now be described. FIG. 2 is an array of partially completed display elements 10 having a flexible common flexible substrate 15 in accordance with the prior art. U.S. Pat. No. 6,236,442 discloses coating an emulsion of polymer-dispersed cholesteric liquid-crystal material over common flexible substrate 15 using photographic equipment. Such equipment creates a uniform coating of cholesteric layer 30 over the array of partially completed display elements 10 on common flexible substrate 15. The coated material must be removed or penetrated to form an electrical connection to first conductors 20. Material deposited outside areas defining the boundary of partially completed display elements 10 is considered waste. In U.S. Pat. No. 6,469,757 to Petruchik such material is removed by a skiving process, thereby forming stripes comprising the partially completed display elements. However, such skiving can damage the first conductors.

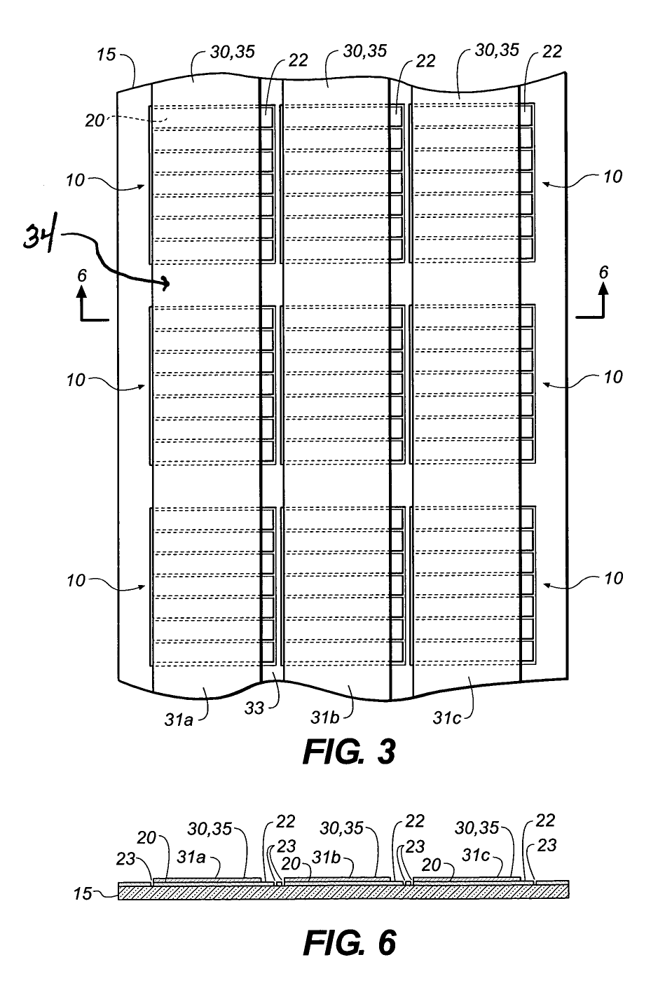

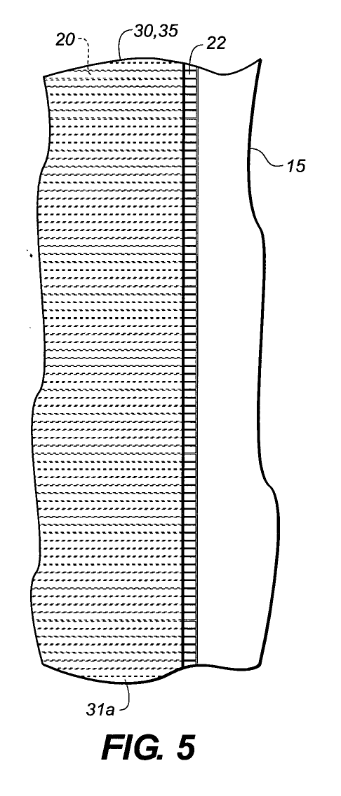

FIG. 3 is top view of a continuous common flexible substrate 15 having a plurality of partially completed display elements 10 (manufacturing intermediates for display elements 10) in accordance with the present invention. The arrow shows the movement of the flexible substrate during the stripe coating operation in this embodiment. The outside periphery of the sets of first conductors 20 of each display element is shown outlined, in part by a dotted line. Within the dotted periphery, there typically are formed a plurality of first conductors in the form of narrow bars. (Although only seven bars are diagrammatically shown in FIG. 3, they are intended to represent numerous bars as more accurately depicted in FIG. 5, in, magnified view compared to FIG. 3.) The sets of first conductors 20 on common flexible substrate 15 are formed for each individual display element 10 on the common flexible substrate 15 and arranged in series along each coated stripe layer of cholesteric material. In accordance with one embodiment of the invention, polymer-dispersed cholesteric material is striped layers 31a, 31b, 31c is selectively deposited over the sets of first conductors 20 in a manner that leaves portions of each of the first conductors 20 in the set of first conductors exposed for each display element 10. The method permits roll-to-roll manufacture of display elements on a common flexible substrate 15 with minimal waste of deposited polymer-dispersed cholesteric layer 30. The exposed transparent first conductors 22 can be seen in the uncoated longitudinal space 33. This uncoated space allows (as shown later), in the completed display, electrical connection with contacts to a driver for the display that may be coupled or uncoupled to the display. The width of the exposed first conductors 22 in the space 33 can vary, and may even essentially fill the entire space. It will be noted that a leader space 34 may exist between display elements, the length of which can also vary, preferably shortened to reduce waste during later singulation of the display elements.

The display elements 10 can be arrayed as shown in FIG. 3 or there can be any number of rows (and corresponding stripes and longitudinal spaces) on a flexible substrate in the form of a moving web. Alternatively, a non-continuous common flexible substrate 15 in the form of a separate sheet of any length short of a web and having an array, or plurality, of display elements 10 can be transported, for example by means of a conveyer belt.

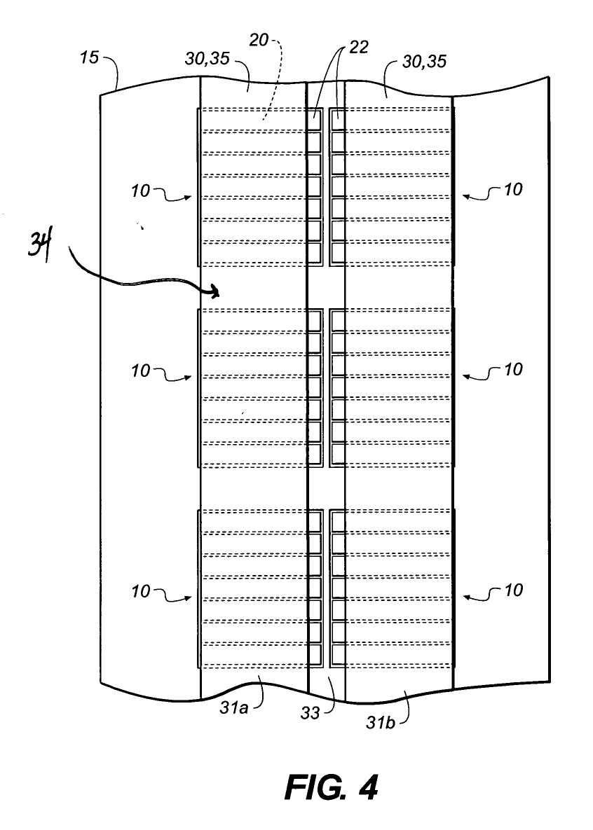

FIG. 4 shows a top view of an alternate embodiment of the present method showing a continuous common flexible substrate 15 having a plurality of partially completed display elements 10 (actually manufacturing intermediates for display products), in which the display elements are separated in the direction of the arrow by leader spaces 34, in accordance with the present invention. The periphery of the sets of first conductors 20 of each display element is shown in part outlined by a dotted line. The sets of first conductors 20 are formed for each individual display element 10 on the common flexible substrate 15 and arranged in series along each coated stripe layers 31a, 31b of cholesteric material. In accordance with this embodiment of the invention, polymer-dispersed cholesteric material in striped layers 31a, 31b is selectively deposited over the sets of first conductors 20 in a manner that leaves portions 22 of each of the first conductors 20 in the set of first conductors exposed for each display element 10 and wherein the exposed longitudinal area, between the adjacent rows of display elements covered by adjacent stripes of cholesteric material, provide unexposed transparent first conductors that are adjacent and parallel. In this embodiment, a single longitudinal space 33 contains the exposed portions 22 of the first conductors for both series of elements in, respectively, stripes 31a and 31b. The width of the two sets of exposed portions of-first conductors 22 in the space 33 can vary, and may even essentially fill the entire space, although a separation between adjacent exposed conductors is shown in FIG. 4 for clarity. It will be noted that a leader space 34 may exist between display elements, the length of which can also vary, preferably shortened to reduce waste during later singulation of the display elements.

FIG. 5, as mentioned above, is a more detailed, magnified top view of an individual display element such as shown diagrammatically in FIG. 3, having patterned transparent first conductors 20 coated with cholesteric material. FIG. 5 shows the numerous first conductors 20 that are typically used in pixilated display, which was diagrammatically represented by a lesser number of first conductors in FIG. 3 for purposes of simplification. First conductors 20 can be formed by laser etching electrically separated areas on an ITO coating. (The space between first conductors can be very narrow (on-the micron scale) and the width of the etching is, therefore, not shown to scale in the figures.) First conductors can also be printed organic conductors such a PEDOT using conventional coating or printing techniques.

In a preferred embodiment, cholesteric material in the form of an emulsion is deposited as a layer of wet polymer-dispersed cholesteric liquid crystal over first conductors 20, leaving uncovered portions 22. The deposited emulsion thickness is set by the concentration of emulsion material, the flow rate of the material and the machine coating speed. In one embodiment, the parameters are selected to provide a 61-micron thick wet coating of emulsion. The viscosity of the emulsion can also be controlled by the concentration of liquid carrier, in this case water, in the emulsion and by controlling the temperature of coating.

FIG. 6 is a side view of the display element of FIG. 5, taken through line 6-6 of FIG. 3, including a portion of an adjacent striped area on the common flexible substrate 15, in which dried cholesteric material has been selectively coated as striped cholesteric stripe layer 31a and 31b over first conductors 20 leaving uncovered areas of first conductors 22. Etched space 23 is present between parallel sets of first conductors. Material has been deposited only in areas needed for image display.

Other means for selectively coating or depositing additional layers (including, for example, gel layers, dark layers, additional cholesteric layers, etc.) can be used downstream or upstream from the coating station for the cholesteric layer. For example, other layers can be deposited employing a mask, gravure printing, screen printing, transfer printing, spray printing, inkjet printing, or other conventional printing means known to the skilled artisan. In yet other embodiments, as described layer, stacked layers in a striped coating can be applied simultaneously, for example, a gel layer and a cholesteric layer, or a nanopigment layer and a cholesteric layer, or a gel layer and a cholesteric layer and a nanopigment layer can be applied simultaneously in a stripe coating.

Subsequent to the stripe coating of cholesteric material according to the present invention, second conductors can be applied to the display elements, for example, on the same moving substrate 15 shown in FIG. 3 after selective coating of the polymer dispersed cholesteric layer. Alternatively, second conductors can be applied to display elements after the array of display elements have been divided or cut into discrete sheets containing a selected subset of display elements or singulated into an individual display element.

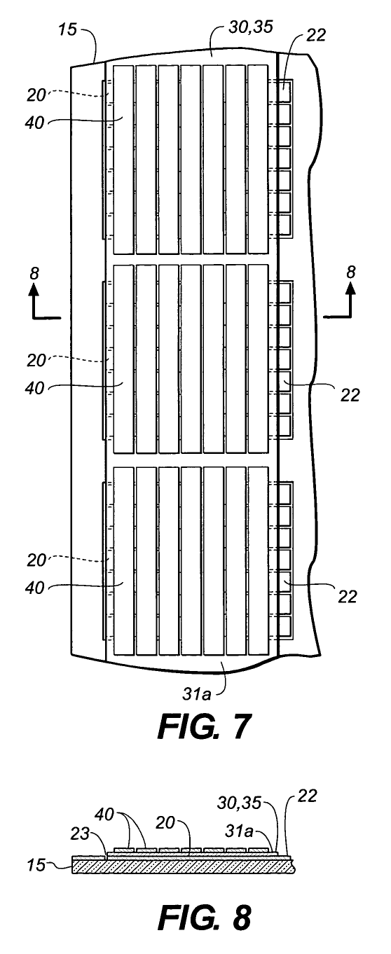

FIG. 7 is a top view of one embodiment of the display elements of FIG. 5 with the later addition of printed second conductors 40. Second conductors 40 can be printed over dried polymer dispersed cholesteric material 30 in stripe 31a. Under cholesteric material 30, an ITO coating is shown covering flexible substrate 15 and first conductors 20, including exposed portions 22, are etched into the ITO coating. Optionally, printing portions of the same material used to create second conductors 40 over the exposed transparent first conductors 20 can be used to provide protective covering or pads over exposed first conductor 22.

FIG. 8 is a bounded side view of a completed individual display element (singulated from the continuous substrate) with printed second conductors 40 having electrically addressable pixels, which side view is taken through section 8-8 of FIG. 7, showing cholesteric layer 30, etched line 23 in a first conductive layer forming first conductor 20, and exposed portion 22 on flexible substrate 15.

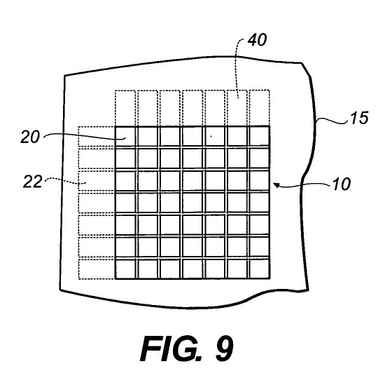

FIG. 9 is a schematic drawing of an extended front view (viewed from the support or substrate side of flexible substrate 15) of the single display element 10 of FIG. 8 comprising a front display area which display element 10 has been singulated from the display elements 10 shown in FIG. 8. Display element 10 has pixels shown in bolder line. Referring to FIG. 8 and 9 together, contacts can be applied, respectively, to each first conductor 20 with exposed conductor portion 22 and each second conductor 40. Appropriate electrical signals applied to first conductors 20 and second conductors 40 permit writing of image data onto display element 10.

As mentioned earlier, a second striped coated layer (stacked under or over the striped cholesteric layer) can comprise a dark layer (i.e., a pigmented or dyed layer) coated between the cholesteric layer and second conductors, to improve the contrast of display element. Alternatively, a second or third striped coated layer can be another emulsion containing cholesteric liquid crystal different in properties than the first cholesteric layer.

For example, the second striped coated layer can comprise a background nanopigment layer or the second striped coated layer or can comprise a differently colored cholesteric liquid-crystal material. The differently colored cholesteric liquid-crystal material can be a different wavelength of light reflected by the planar state, in order to provide multicolor displays.

The displays described above can be combined with conventional components to obtain an integral self-contained system. For example, matrix driving of such cholesteric displays are well known in the art, as for example, described in U.S. Ser. No. 10/085,851 filed Feb. 28, 2002, hereby incorporated by reference in its entirety.

The method of the present invention is also applicable to the manufacture of segmented displays, as compared to the pixilated displays shown in FIG. 1A and FIGS. 2 to 9.

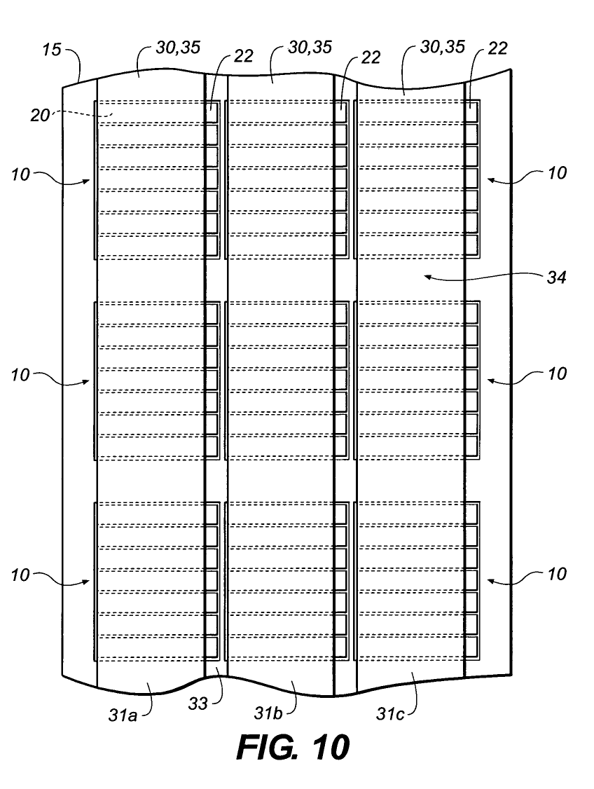

FIG. 10 is a rear view of a sheet in accordance with the one embodiment of the present invention, which sheet has a plurality of patterned first conductors 20 provided on a flexible substrate 15. Shown are several partially completed display elements 10 (i.e., manufacturing intermediates for display elements 10). The arrow shows the movement of the flexible substrate during the stripe coating operation in this embodiment. A set (or plurality) of first conductors in the form of individual segments are typically formed, for example rectangular in shape, each segment corresponding, for example, to an alphanumeric character or other indicia or picture element as desired. As shown, the sets of first conductors 20 for each individual display element 10 are arranged in series along each coated stripe layer of cholesteric material. In accordance with one embodiment of the invention, polymer-dispersed cholesteric material in striped layers 31a, 31b, 31c is selectively deposited over the sets of first conductors 20 in a manner that leaves portions 22 of each of the first conductors 20 in the set of first conductors exposed for each display element 10. The method permits roll-to-roll manufacture of display elements on a common flexible substrate 15 with minimal waste of deposited polymer-dispersed cholesteric layer 30. The exposed transparent first conductors 22 can be seen in the uncoated longitudinal space 33. This uncoated space allows (as shown later), in the completed display, electrical connection with contacts to a driver for the display that may be coupled or uncoupled to the display. The width of the exposed first conductors 22 in the space 33 can vary, and may even essentially fill the entire space. It will be noted that a leader space 34 may exist between display elements, the length of which can also vary, preferably shortened to reduce waste during later singulation of the display elements.

The display elements 10 can be arrayed as shown if FIG. 10 or there can be any number of rows (and corresponding stripes and longitudinal spaces) on a flexible substrate in the form of a moving web. Alternatively, a non-continuous common flexible substrate 15 in the form of a separate sheet of any length short of a web and having an array, or plurality, of display elements 10 can be transported, for example by means of a conveyer belt.

The striped coating of FIG. 10 can optionally be singulated into sheets at this stage, as mentioned above, and additional layers can be applied on the sheets. Second conductors are applied over the cholesteric layer and dark layer.

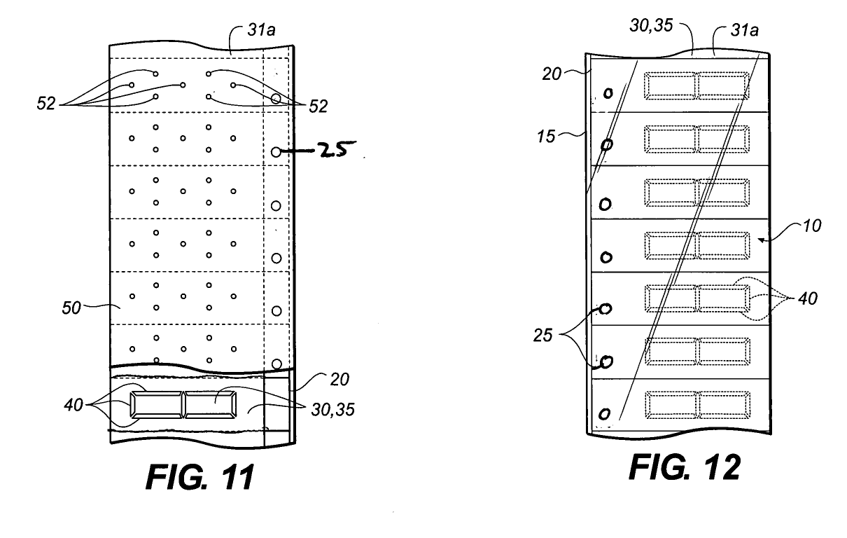

FIGS. 11 (front view) and 12 (rear view) illustrate more than one stage of the method, in which second conductors 40 have been printed over dark layer 35. FIG. 11 also shows a dielectric layer 50 that is printed over the second electrodes and the creation of via holes 52 to allow electrical connection to the second electrodes 40. Other via holes 25 in the dielectric, in the inter-stripe longitudinal space, can be made to connect to the first electrodes. The skilled artisan will understand that other ways to allow for electrical connection, to the first and second conductors, in the inter-stripe longitudinal space can be designed. For example, the dielectric layer can be patterned in the the inter-stripe longitudinal space, for example to form isolation pads, such that via holes 25 are not needed. The via holes may be any shape, but are preferably either circular or rectangular. Still another alternative is to pattern the exposed first conductors 22 such that a portion of the ITO is removed where conductive contacts for the second electrodes are placed, so that the top and bottom electrodes are electrically isolated.

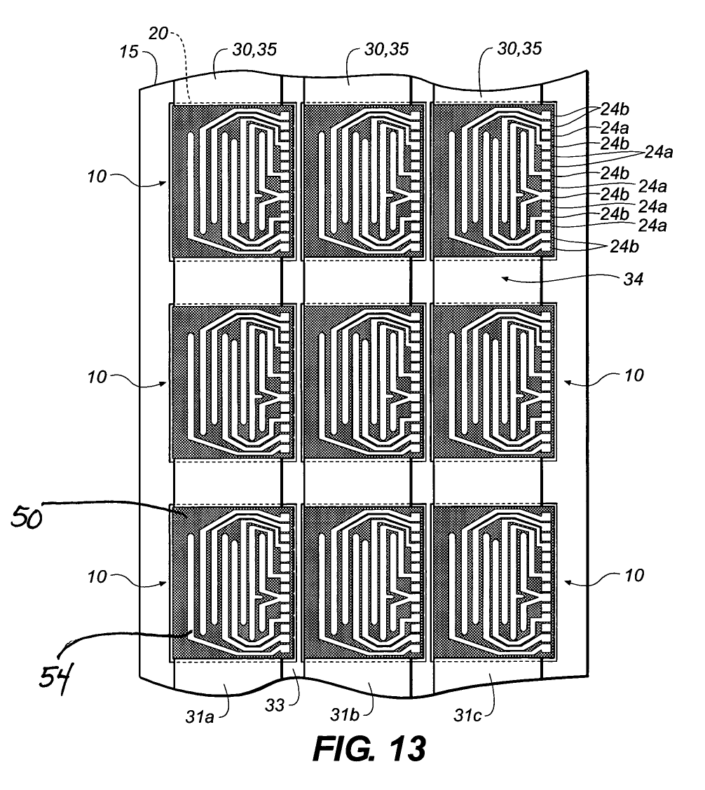

FIG. 12 is a front view of the display 10 in accordance with the present invention, as seen through the transparent support 15, in which the second electrodes 40 are shown under the striped layer 31a. The via holes 25 in the applied dielectric layer 50 permit access to the first conductors 20. Dielectric layer 50 covers second conductors 40, and the through-via 52 permits access to second conductors 40.

The through-via 52 can permit connection to segmented second conductors 40 to permit writing of cholesteric liquid crystal material to either the focal-conic or planar state during display use. Design of multiple printed layers to create a matrix driven seven-segment display having electrically writable inter-segment material are incorporated in co-pending U.S. application Ser. No. 10/426,539 (docket 85,836), which application is hereby incorporated by reference in its entirety.

Instead of coating a dielectric layer, air may be used as a dielectric material in combination with suitable spacing achieved by contacts.

FIG. 13 is a plan view of a display element or sheet (still a manufacturing intermediate for a display) in accordance with the present method invention after the application of third conductors over the dielectric layer. FIG. 13 shows flexible substrate 15, individual display elements 10, coated stripes 31a, 31b, 31c and inter-stripe gaps or spaces 33, in which are conductive contacts 24a, 24b. Conductive contacts 24a provide electrical connection with exposed first conductors 22. Conductive contacts 24b provide electrical connection to second conductors via the third conductors 54). The stripes include cholesteric layer 30 and dark layer 35, for example comprising a nanopigment, over which dark layer 35 is coated the dielectric layer 50.

Conductive traces 54 are printed to connect common second conductors using through vias 52 (shown in FIG. 12) in dielectric layer 50. The conductive traces or third conductors. 54 form a predesigned path leading to conductive contacts 24a, 24b for a display driver, in the longitudinal spaces 33. A leader space 34 may exist between display elements 10, the length of which can also vary, preferably shortened to reduce waste during later singulation of the display elements. Especially in the case where the dielectric is patterned, instead of using via holes 25, to expose the first conductors in the inter-stripe longitudinal space, the conductive contacts 24a can be viewed as protective pads on the exposed portions of transparent conductors 22, which transparent conductors 22 are typically made of ITO which can be subject to undesirable scratching. In the embodiment shown in the present invention, the conductive contacts, for connection to a display driver, are advantageously all in the longitudinal space along the side of the display characters, thereby obviating the need for removing a portion of the imaging layer or other layers that have been coated over the first conductors in order to allow contact,with the first conductors.

A completed display assembly in accordance with the present invention can be connected to an electric driver via driver contacts (for both the first and second conductors) to conductive contacts 24a, 24b, which is connected to conductive traces 54 in FIG. 13. The driver can be connected by driver contacts to the conductors through protective covers or pads, as mentioned above. Electrical signals can be applied to the driver to write images onto the display. Segments of the display are typically written into the darker, focal-conic state to present image data. Writing data segments back into the electrically written planar state merges the previously written area into an optically continuous background.

In use, a display can, for example, comprise a circuit board attached to the assembly made. Contacts on the circuit board can provide electrical connection to each second conductor and first conductor via contacts in the uncoated space adjacent the striped material, the overall assembly of which will be understood by the skilled artisan.

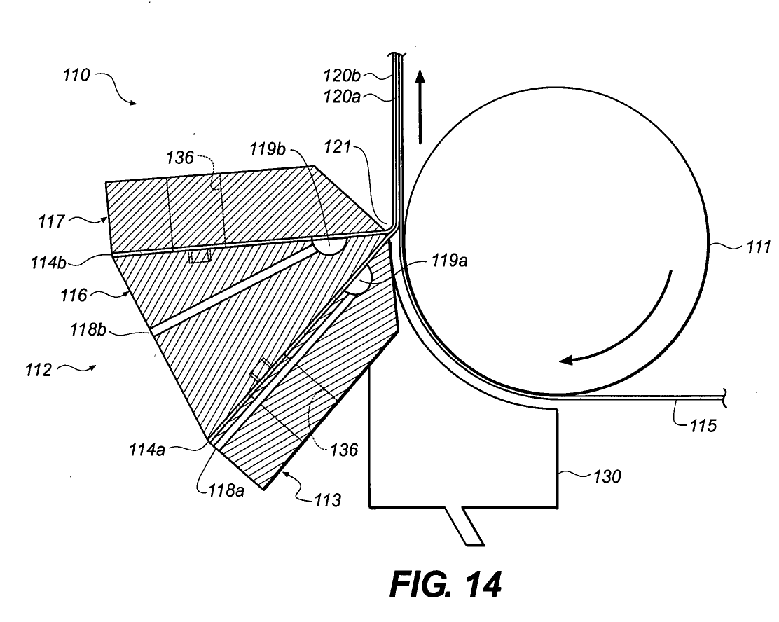

FIG. 14 is a schematic, partially sectional view of one embodiment of a die-coating apparatus 110 that may be used to produce flexible sheets of a polymer-dispersed electro-optical fluid according to the invention. Flexible web 115 is conveyed in the direction of the arrow through a coating zone by a conveyance means that includes a backing roller 111, which precisely positions the flexible web 115 in relation to the die assembly 112. The die assembly 112 includes lower die element 113, bottom layer shim 114 a, center die element 116, second-layer shim 114b, and upper die element 117. The die assembly 112 can distribute a plurality of coating liquids, of the desired stripe width by means of feed conduits 118a, 118b and cavities: 119a, 119b. Coating liquids are supplied to the feed conduits 18a, 18b at the desired flow rate by appropriate fluid delivery means (not shown). Through openings 136 (for example, slots or holes) are provided, on opposite sides of die elements 113 and 117, extending through shims 114a, 114b respectively and forming threaded cylinders for attachment by a fastening means such as a threaded bolt (not shown) in order to fasten the die elements and shims together, as is well known in the art. Additional positioning means well known in the art such as dowels and dowel holes (not shown) can be used to further position the shims and die elements.

The moving flexible web 115 receives the superimposed (stacked) coated striped layers 120a and 120b formed by the die assembly 112 on its surface at coating bead 121. The superimposed coated striped layers 120a and 120b move to subsequent operations such as chill setting and drying (not shown). It is also possible to have additional layers (continuous coatings, striped coatings, or otherwise selectively coated layers) coated in a downstream operation.

The die-coating (or slot-coating) apparatus 110 can also include a low-pressure or suction chamber 130 that is used to stabilize the coating bead 121 by imposing a pressure difference across the coating beads for obtaining uniform coating laydown for each stacked stripe of material. Such a suction chamber is disclosed, for example, in U.S. Pat. No. 2,681,294 to Beguin, incorporated herein by reference.

In accordance with the present invention, the spaced distance of longitudinal spaces 33 (shown in FIG., 3) between individual stripes can be as low as 0.75 mm (0.030 inch) and as high as 50 mm (2 inches) when the coating beads are stabilized by the suction chamber. Preferably, the spacer width between stripes is 1.5 mm to 12.0 mm (about 0.06 to 0.48 inch), more preferably about 2.0 mm to 6.0 mm (about 0.080 to 0.24 inch). The width of one or more of the stripes can depend on the size of the display elements and can be, for example, 100 mm (4 inches), 500 mm (20 inches), 1500 mm (about 60 inches) or higher, depending on whether the display is used for a label, outdoor signage, or other application. The widths of the spaces and stripes can independently vary or not as desired.

In accordance with one embodiment of the present invention, the stripes of coating composition are formed in the die assembly by means of shims that are placed between die-element surfaces that are in a parallel, face-to-face relationship, in which one of the element surfaces contains a fluid distribution cavity. In the preferred embodiment, the shim is a thin relatively flat piece that is wedged between the die elements to control the flow of materials through the die assembly and out the slots of the die assembly.

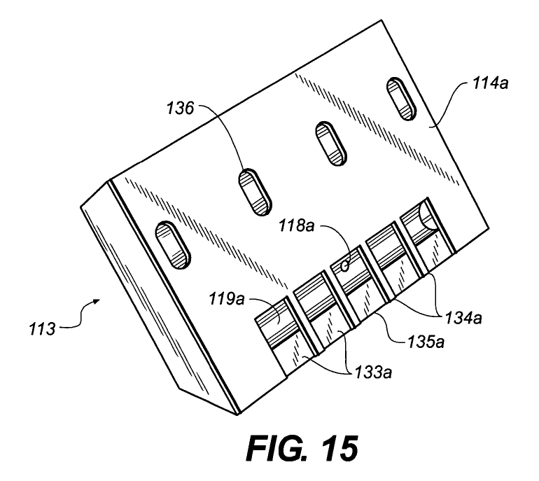

FIG. 15 shows the lower die element 113 and bottom-layer shim 114a of the die-coating device 110 of FIG. 14. In this embodiment, the shim, which can be metallic or plastic or other solid material, is used to distribute the bottom coating composition (herein referred to as coating fluid A) for a plurality of coated striped layers such as coated stripe layer 120a into a plurality of longitudinally parallel transversely discontinuous stripes. Coating fluid A enters the die assembly through conduit 118a which communicates with cavity 119a which distributes the coating fluid A in stripes in a direction perpendicular to the edge of the flexible web to be coated. Bottom-layer shim 114a contains distribution passages 133a. However, flow is prevented from occurring in the areas covered by the projecting portions or distribution blocks 134a of the shim 114a. Thus, spaced-apart stripes of the bottom layer coating fluid A are formed through this arrangement of distribution passages 133a and distribution blocks 134a of the bottom-layer shim 114a. The precise width of the stripes of bottom-layer coating composition can be controlled by the arrangement of distribution passages 133a and distribution blocks 134a of shim 114a. Similarly, the position of the stripes of bottom layer coating fluid A relative to the edges of the flexible web 115 can be controlled by the position of the die assembly relative to the edges of the substrate 115. Through openings 136 (for example, slots or holes) are provided in shims 114a, 114b and die elements 113, 116, and 117 of FIG. 14 to fasten the die elements and shims together using fastening means as mentioned above.

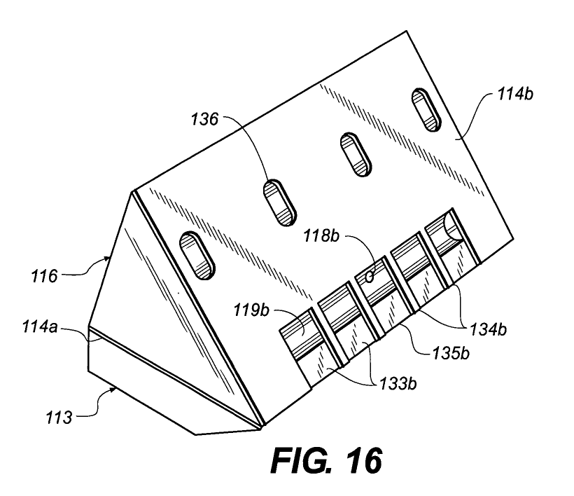

FIG. 16 is a top view of the center die element 116 and upper, second-layer shim 114b in the slot-coating apparatus of FIG. 14. Second-layer shim 114b is placed between the top face of center die element 116 and the lower face of the upper die element 117 (not shown in FIG. 16). A secondary coating fluid B enters the center die element 116 through conduit 118b which communicates with cavity 119b and which distributes the coating liquid in stripes in a direction perpendicular to the edge of the flexible web to be coated. Second-layer shim 114b contains distribution passages 133b and distribution blocks 134b. However, flow is prevented from occurring in the areas covered by the distribution blocks 134b of the shim 114b. Thus, stripes of second-layer coating fluid B are formed through this arrangement of passages 133b and distribution blocks 134b of the second-layer shim 114b. This secondary layer of coating composition is superimposed, in register, on the bottom layer at the middle lip 135b by aligning distribution passages 133b and distribution blocks 134b of second-layer shim 114b with the distribution passages 133a and distribution blocks 134a of bottom-layer shim 114a associated with lower die element 113.

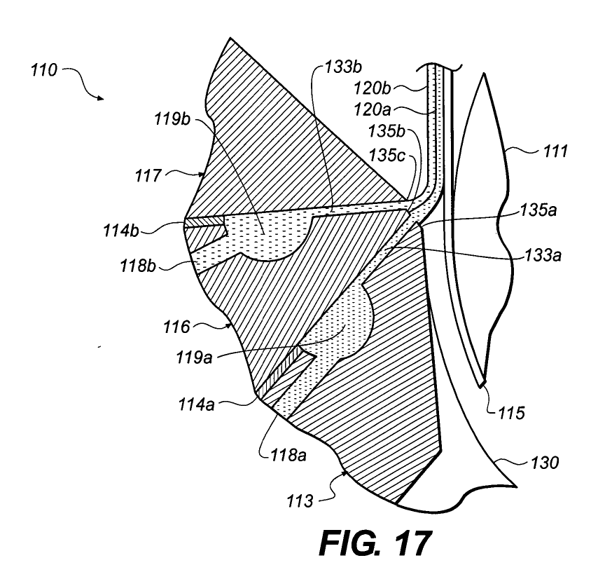

As shown in FIG. 17, coating fluid A flows from cavity 119a to the lower and middle lips 135a, 135b through the distribution passages 133a, and coating fluid B flows from cavity 119b to the middle and upper lips 135b, 135c through distribution passages 133b. It then makes contact with the flexible web 115, which is against the backing roll 111.

The skilled artisan will appreciate that conventional coatings dies can be used instead of the die assembly of FIG. 14, depending on the application or the coating pattern and number of layers. Also, alternate embodiments of the die assembly of FIG. 14 can involve, for example, replacing one or more of the shims by machining/grinding the shim shape directly into the die elements themselves. However, this is a less versatile approach, since shims can be easily substituted between die elements for coating different patterns, shapes and various size stripe widths and spaces, etc.

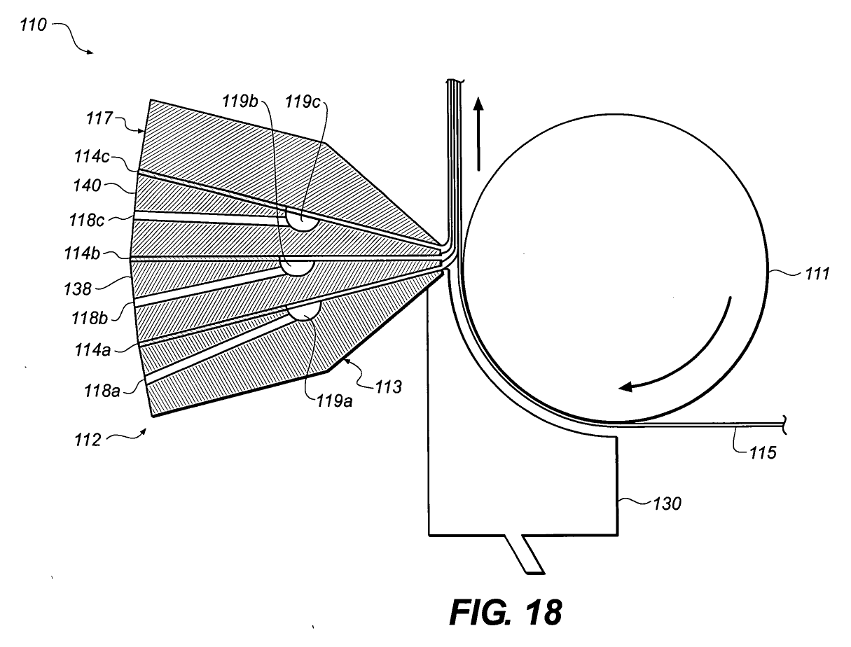

Also, a similar die assembly can be made that coats three-stacked stripes by having two center die elements, as will be understood by the skilled artisan, wherein an additional center die element which can be positioned between the lower die element 113 and center die element 116 shown in previous figures. Such an embodiment is seen in, FIG. 18 showing a schematic, partially sectional view of a one embodiment of a slot-coating apparatus 110 used to produce flexible sheets of a polymer-dispersed electro-optical fluid according to the invention. Flexible web 115 is conveyed in the direction of the arrow through a coating zone by a conveyance means that includes a backing roller 111, which precisely positions the flexible web 115 in relation to the die assembly 112. The die assembly 112 includes lower die element 113, bottom-layer shim 114a, a first center die element 138, second-layer shim 114b, second center die element 140, a third-layer shim 114c, and upper die element 117. The die assembly 112 can distribute a plurality of coating liquids of the desired stripe width by means of feed conduits 118a, 118b, 118c and cavities 119a, 119b, 119c. Coating liquids are supplied to the feed conduits 18a, 18b, 18c at the desired flow rate by appropriate fluid delivery means (not shown). The moving flexible web 115 receives the superimposed (stacked) coated striped layers formed by the die assembly 112 on its surface. A low-pressure or vacuum chamber (suction chamber) 130 is used to stabilize the coating beads formed at the slot opening by imposing a pressure difference across the coating beads, thereby promoting uniform coating laydown for each stacked stripe of material.

The above-described die set can be made utilizing conventional mold-making art. However, a precision fabrication technique will be required to control the tolerance within a few micrometers, when the width of the coating stripes is reduced to a level of 20-150 micrometers.

According to one embodiment of the present invention, an extended coating layer is formed comprising a plurality of spaced-apart parallel stripes, each stripe composed of at least two different materials in an arrangement of vertically stacked stripes on top of one another comprising in a repeated pattern, at least two stripes alternating with at least one uncoated space or indentation in the extended coating layer, comprising a pattern as follows:

$$\frac{B}{A} ** \frac{B}{A} or \frac{B}{A} ** \frac{B}{A} ** \frac{B}{A}$$

wherein the symbol “**” implies that there is no coating between two adjacent stripes. A and B represent at least two different coating liquids, and B has a distinct interface with A in each stripe. The width of the lateral space between the stripes is relatively narrow compared to the width of the stripes. Preferably such stripes are formed under suction.

Another embodiment of the present method comprises forming an extended coating layer comprising a plurality of spaced-apart parallel stripes, each stripe composed of at least two different materials in an arrangement of vertically stacked stripes on top of one another comprising in a repeated pattern, at least two stripes alternating with at least one uncoated space or indentation in the extended coating layer, comprising a pattern as follows:

$$\begin{matrix}\underline{C} \\ \underline{B} ** \\ A\end{matrix} \begin{matrix}\underline{C} \\ \underline{B} \\ A\end{matrix} or \begin{matrix}\underline{C} \\ \underline{B} ** \\ A\end{matrix} \begin{matrix}\underline{C} \\ \underline{B} ** \\ A\end{matrix} \begin{matrix}\underline{C} \\ \underline{B} \\ A\end{matrix}$$

wherein the symbol “**” implies that there is no coating between two adjacent stripes. A, B, and C represent at least two different coating liquids, and B has a distinct interface with A and C. The width of the lateral space between the stripes is relatively narrow compared to the width of the stripes. Preferably, the stripes are formed under suction.

At least one of A and B comprise an electro-optical fluid having a plurality of optical states responsive to electric fields. In one embodiment of the invention, liquids A, B and C correspond to three different materials, for example a gelatin subbing layer, an imaging layer comprising an electro-optical material, and a dark layer. In another embodiment, any two of A, B, and C can be different materials. The electro-optical fluid can comprise a liquid crystal or an electrophoretic material. For example, in the case where displays are being manufactured, both A and B can comprise an electro-optical material and can comprise a darkly pigmented material, for example, a nanopigment.

In one embodiment of the method of the present invention, further steps can comprise coating a second field-carrying layer over the extended stripe-coated layer and forming second conductors. The method can further comprise depositing a plurality of tracers that connect the second conductors to contact points located in the space between stripes, optionally with a dielectric layer coated between the second conductors and the tracers.

Since the stripes can form longitudinal rows of a series of potential individual elements, subsequent manufacturing operations include cutting the stripes perpendicular to their longitudinal direction to form individual elements; and/or cutting the coated web in the longitudinal direction to form stripes each containing a single stripe and at least a portion of at least one space between stripes. If the flexible web is only coated where needed by the use of a die set that restricts the flow of the material used to form stripes, then the selective removal of material from the extended layer, such as by skiving, can be partially or completely avoided.

In a preferred embodiment, an elongated lower outlet slot, comprising spaced lips, is located between the lower die element and center die element, and an elongated upper outlet slot, comprising spaced lips, is located between the center die element and the upper die element, the lower outlet slot and the upper outlet slot being parallel and adjacent.

Each of the shims is a thin, relatively flat piece that is wedged between two of the die elements to control the flow of materials through the die assembly and out the slots of the die assembly, wherein one of the center die elements is located between the other two die elements, the upper and lower interfacial fluid-flow spaces being located on two different sides of the center die element. The die assembly can, of course, be made to contain additional shims. Guide or spacer shims can be included in the die assembly or the above-described shims can be divided into a plurality of shims. The thickness of each of said shims corresponds to the desired thickness of the fluid coating within the die assembly.

The vertically projecting portions of the shims are, in one embodiment, in the form of legs as seen in top planar view of the shim. The cavities are in the form of grooves formed in the interfacial planar surface of one of the interfacing die elements, wherein the grooves are open to the interfacial space between die elements which spatially communicates with the outlet slot between die elements, and wherein the vertically projecting portions spatially separate the flow of coating fluid between channels. In the preferred embodiment, the width of the channels for forming the parallel stripes is substantially greater than the width between the vertically projecting portions for forming the space between the stripes. Similarly, the width of longitudinally space-apart substantially parallel stripes is relatively larger than the space between the stripes, preferably less than 20% of the width. This is believed to promote effective suction to enhance bead formation despite the gaps between beads. Preferably, the suction is greater than 0.1 inches water gauge or iwg (2.5 mm), preferably 3 to 5 iwg (76 mm to 127 mm), more preferably greater than 3.5 iwg (89 mm).

In one embodiment, for example, the striped coating when wet is 10 to 200 microns when first coated and 2 to 20 microns when dried. In the case of a stacked striped layer, the top layer has, for example, a wet coverage of 1 to 6 cc/ft² (11 to 65 cc/m²), preferably greater than 1.3 cc/ft² (14 cc/m²). Similarly, the bottom layer has, in one application, a wet coverage of greater than 38 cc/m² to 76 cc/m².

In the case of vertically stacked layers, comprising an upper layer and a lower layer, relative to the: flexible substrate, the upper layer preferably has a higher viscosity than the lower layer. More preferably, the viscosities of the upper layer and the lower layer are 2 to 150 Centipoises.

In one embodiment, the width of the stripes is 5 mm to 2500 mm (2 inches to 100 inches) and the width of the longitudinal spaces between stripes is 0.5 mm (0.020 inch) to 500 mm (20 inch), preferably at least 1.0 mm ( 1/16 inch).

In such an embodiment, the thickness of each of said shims, corresponding to the thickness of the fluid coating within the die assembly, is 0.076 mm to 0.51 mm (5 to 10 mils). Similarly, the width of the distribution passages for forming the parallel stripes is between 1.5 to 50 mm and the width between the distribution blocks for forming the spaces between the stripes is, respectively, 0.5 mm to 4 mm.

The die assembly is adapted to separately distributes the two coating liquids A and B, respectively, in (a) the lower interfacial fluid-flow space between the lower die element and the center die element to form an extended coating bottom layer in the form of stripes A; and (b) the upper interfacial fluid-flow space between the center die element and the upper die element to form an extended coating secondary (upper) layer in the form of stripes B.

Accordingly, each of two sets of stripes of coating composition can be formed in the die assembly by means of each of said shims which is placed between two die-element interfacial surfaces that are in a substantially parallel, face-to-face relationship, in which one of the element surfaces contains a fluid distribution cavity. A secondary layer of coating composition is superimposed on a bottom layer at the lip of the outlet slot by aligning channels and projecting portions in the upper shim with channels and projecting portions in a bottom shim such that the channels are adapted to form parallel stripes of coating fluid and the spaces between projecting portions are adapted to correspond to the space between the parallel stripes.

In one embodiment of the die assembly, the center die element has, in cross-section, a substantially triangular shape, wherein the upper outlet slot and the lower outlet slot share an intermediate edge corresponding to a corner of the triangular shape of the center die, which corner is the portion of the center die element positioned most proximate to the substrate to be coated.

The lower die element and bottom-layer shim of the slot-coating device is adapted to distribute the bottom coating composition (coating fluid A) into a plurality of longitudinally parallel discontinuous stripes. A conduit is adapted to introduce coating fluid A into the die assembly and communicates with a cavity adapted to distributes the coating liquid in a direction perpendicular to the edge of the substrate to be coated. The bottom-layer shim contains channels adapted to cause coating fluid A to flow from a cavity to a lower lip of the bottom die element through channels, but vertically projecting portions in the shim are adapted to prevent flow from occurring in the areas covered by the vertically projecting portions of the shim. Whereas the channels are adapted to form spaced-apart stripes of the bottom layer coating composition A, the vertically projecting portions of the bottom layer shim are adapted to form uncoated spaces between the stripes.

Similarly, the upper-layer or second-layer shim is placed between the top face of center die element and the lower face of upper die element, so that a secondary coating composition (coating fluid B) entering the center die element through a conduit communicates with a cavity which is adapted to distribute the coating liquid in a direction perpendicular to the edge of the substrate to be coated. The upper-layer shim contains channels and vertically projecting portions, such that coating fluid B can flow from the cavity to an upper lip of the outlet slot through channels, but wherein flow is prevented from occurring in the areas occupied by the vertically projecting portions of the shim. Accordingly, stripes of upper-layer coating composition B can be formed in the channels but spaces between stripes are formed corresponding to the space occupied by each vertically projecting portions in the upper-layer shim.

The elements of the die assembly are configured such that the stripes of secondary extended layer of coating fluid B are superimposed on top of the stripes of the bottom extended layer of coating fluid A at the upper lip by aligning channels and projecting portions of upper shim with channels and projecting portions of bottom layer shim, whereby stacked stripes can be formed by the die assembly.

The die assembly can-be used in an apparatus for stripe coating on a web, wherein the die assembly is further in combination with a means for advancing a web to be coated across and closely adjacent the outlet slots of the die assembly to receive coating fluid there from in the form of stripes corresponding in width and location to the channels in said shims, and further in combination with a suction chamber for imposing a pressure difference across the coating bead for each stacked stripe of material. The means for advancing the web can be a rotatable drum or similar means.

The stripe coating can be applied over many different types of web materials with many different kinds of liquid coating compositions. For example, the web can be composed of paper, polymer-coated paper such as polyethylene-coated paper, metal foil, or plastic film such as cellulose acetate, polyvinyl acetal film, polyethylene film, polypropylene film, polycarbonate film, polystyrene film or a polyester film.

Web materials that can be successfully stripe-coated with the apparatus described herein can be any suitable width. The stripes can also vary in width as desired and can be spaced a desired distance between stripes. The apparatus can be used to apply stripes of different width and/or different spacing across the width-wise extent of the web, as desired, although uniform stripes and spacing will be among the useful configurations. In sum, the dimensional characteristics of the manufactured product can be varied widely to meet the objectives of a particular end use.

### EXAMPLE 1

A coating pack of a two-layer gelatin system was applied to a substrate having a 250-Angstrom thick conductive layer of an Indium Tin Oxide (300 ohms per square) on a 120-micron polyethylene terephthalate substrate, using a slot hopper. The Indium Tin Oxide coated on the polyethylene terephthalate was prepared by Bekaert Specialty Films, LLC, San Diego, Calif. The bottom layer coating composition was a 5 wt % gelatin material containing 13.3 wt % of MERCK BL118 droplets of cholesteric liquid crystal oil, available from E.M. Industries of Hawthorne, New York, U.S.A. The droplets, created by a limited coalescence per Stephenson U.S. Pat. No. 6,556,262 B1, had a volume mean diameter of 10 microns. The coating solution was heated to 45° C., which reduced the viscosity of the emulsion to approximately 8 centipoises. A three percent by weight gelatin cross-linker bisvinylsulfonylmethane was dueled with the bottom layer coating solution immediately prior to coating. The dueled solution was continuously coated on the coated substrate at 61.5 ml/m² on a photographic coating machine.

The top layer coating solution was prepared using 4 wt % gelatin and a mixture of pigments formulated to provide a neutral black density. The second coating solution was heated to 45° C., and the viscosity of the solution was approximately 100 centipoises. The solution was continuously coated on the coated substrate at 10.76 ml/m² on a photographic coating machine.

A gelatin sub layer was prepared as follows. The coating for the gelatin sub layer contains 2% gelatin by weight with a surfactant (ARCH CHEMICALS, INC., Norwalk, Conn. 10G diluted to 10% active ingredient) added to it for coating purposes.

In the case of the gelatin sub layer, the, coating composition was heated to 40° C., which reduced the viscosity of the emulsion to 2 Centipoises. This layer was coated as three parallel, spaced-apart stripes at a coating station using a single X-hopper, which was selectively deposited, by the use of shims internal to the single X-hoppers.

At a coating station, the bottom-layer coating solution and the top layer coating solution were coated simultaneously in three parallel spaced-apart stripes over the previously coated gel layer, and in register therewith, using a dual X-hopper separated by a wedge. The-two coating solutions were selectively deposited by the use of shims internal to the X-hoppers. A slot coating apparatus was used to coat the three parallel, spaced-apart, vertically-stacked stripes on a sub-layer stripes, thereby forming a total composite stacked stripe, on the support, composed of the gelatin sub-layer, the bottom layer coating composition and the upper layer coating composition

The dimensions of the coating die assembly was as follows:

| | | |
|---|---|---|
| Distance from hopper lip to support | 0.2032 | mm |
| Diameter of hopper cavities | 12.7 | mm |
| Length of flow channels | 25.6 | mm |
| Thickness of shims | 0.254 | mm |
| Width of flow channels | 18.26 | mm |
| Width of shim projection separating portions | 1.60, 2.38, 3.175 | mm |

The two-layer striped coating composition was applied to the gel-coated substrate at a coating speed of 102 cm/s. The machine speed was set so that the temperature of the stacked coating was reduced to 10° C. in a first chill section of the machine. The viscosity of the stacked coating increased so that the coating viscosity changed from a liquid state to a very high-viscosity gel state. The emulsion chill-set hard enough to allow both warm impingement air and the ability to be passed over roller sets in drying areas of the photographic coating equipment to remove the bulk of the water content of the emulsion.

The wet coating thickness of the bottom layer coating composition was 61.5 microns, and the wet coating thickness of the top layer coating composition was 10.8 microns. A stable coating was achieved when a pressure differential of 500 Pascal was applied across the coating bead by means of a suction chamber and vacuum pump. The width of the coated two-layer stripes varied between 18.29 and 18.54 mm which agrees very closely, to within 0.3 mm, of the aim stripe width of 18.26 mm defined by the width of the flow channels of the shims. The excess laydown in the edge regions of the coated stripes was measured by densitometry and found to be within acceptable limits.

The various widths of shim projection portions (1.60, 2.38, 3.175 mm) produced gaps between the stripes that were within 0.25 mm of the width of the stripe shim projection portions.

The resulting dried coating stripe thickness (of both coated layers) was about 9 μm thick. The dried emulsion had flattened domains of cholesteric liquid crystal dispersed in a gelatin polymeric matrix.

The invention has been described in detail with particular reference to certain preferred embodiments thereof, but it will be understood that variations and modifications can be effected within the spirit and scope of the invention.

### PARTS LIST

10 display
15 flexible substrate
20 transparent first conductors
22 exposed transparent first conductors
23 etched lines in conductive layer
24a bottom conductive contact
24b top conductive contact
25 through via for first conductors
30 cholesteric layer
31a coated stripe
31b coated stripe
31c coated stripe
33 inter-stripe longitudinal space
34 inter-display leader space
35 dark layer
40 second conductors
50 dielectric layer
52 through via for second conductors
54 conductive third conductors or traces
110 die-coating apparatus
111 backing roll.
112 die assembly
113 lower die element
114a bottom-layer shim
114b second-layer shim
114c third layer shim
115 flexible web
116 center die element
117 upper die element
118a feed conduit
118b feed conduit
   Parts List—Continued
118c feed conduit
119a cavity
119b cavity
119c cavity
120a coated striped layer
120b coated striped layer
121 coating bead
130 suction chamber
133a distribution passage
133b distribution passage
134a distribution block
134b distribution block
136 through-openings
135a lower lip
135b middle lip
135c upper lip
138 first center die element
140 second center die element

1. A method for making a sheet material, useful for displays, comprising the steps of:
(a) providing a flexible substrate;
(b) applying a first field-carrying layer comprising first conductors over the surface of the flexible substrate;
(c) providing an electro-optical fluid having a plurality of optical states responsive to an electrical field;
(d) coating a plurality of longitudinally spaced-apart substantially parallel stripes, each stripe comprising one or more vertical layers, at least one of which layers comprises the electro-optical fluid, onto the flexible substrate having a field-carrying layer on its surface; and
(e) changing the state of the electro-optical fluid from a liquid to a solid-state electro-optical material.

2. A method for making a multilayer sheet material, useful for displays, comprising the steps of:
(a) providing a flexible substrate;
(b) applying a first field-carrying layer over the surface of the flexible substrate;
(c) providing an electro-optical fluid having a plurality of optical states responsive to an electrical field;
(d) coating a plurality of longitudinally spaced-apart substantially parallel stripes, each stripe comprising at least two vertically stacked layers, at least one of which layers comprises the electro-optical fluid, onto the flexible substrate having a field-carrying layer on its surface; and
(e) changing the state of the electro-optical fluid from a liquid to a solid-state electro-optical material.

3. The method of claim 2 wherein a second layer, in the vertically stacked layers, comprises a functional layer.

4. The method of claim 1 or 2 wherein the flexible substrate is singulated along its length into a series of panels each having a plurality of parallel stripes each corresponding to a plurality of display elements.

5. The method of claim 1 or 2 wherein a second field-carrying layer comprising second conductors is applied over the parallel stripes in panels.

6. The method of claim 5 wherein the stripes are coated between the first and the second field-carrying layer.

7. The method of claim 5 wherein the same material used for the second-field carrying layer is coated in the longitudinal spaces between stripes as protective pads over exposed portions of first conductors.

8. The method of claim 5 wherein the second field-carrying layer is applied by a screen-printing method.

9. The method of claim 5 wherein a dielectric material and conductive traces are applied in sequence over the second field-carrying layer.

10. The method of claim 3 wherein the second layer, in the vertically stacked layers, comprises a dark layer for providing contrast.

11. The method of claim 5 wherein the sheet material is singulated into separate display elements.

12. The method of claim 11 wherein the panels are singulated with a punch die.

13. The method of claim 5 wherein the first and the second field-carrying layers each comprises a patterned electrode.

14. The method of claim 1 or 2 wherein the electro-optical fluid is coated over patterned ITO conductors in step (d).

15. The method of claim 1 or 2 wherein the substrate is a transparent flexible material.

16. The method of claim 15 wherein the substrate comprises a polycarbonate, polyester, cellulose triacetate material.

17. The method of claim 1 or 2 wherein the coating when wet is 10 to 200 microns when first coated and 2 to 20 microns when dried.

18. The method of claim 1 or 2 wherein the width of the longitudinally space-apart substantially parallel stripes is relatively larger than the space between the stripes.

19. The method of claim 1 or 2 wherein the width of the stripes is 5 mm to 2500 mm (2 inches to 100 inches) and the width of the longitudinal spaces between stripes is 0.5 mm (0.020 inch) to 500 mm (20 inch).

20. The method of claim 5 wherein the first and the second field-carrying layers are, respectively, first and second patterned conductor layers, between which is formed the layer of electro-optical material.

21. The method of claim 5 wherein the second conductors are formed, using printed inks and silk screening, over the striped electro-optical material.

22. The method of claim 1 or 2 wherein the substrate being coated is a moving web and, after completing the manufacture of sheet material, including vertically spaced electrodes on either side of coated electro-optical material, the sheet material is singulated into a plurality of displays.

23. The method of claim 1 or 2 wherein the electro-optical fluid is a light-modulating material having an initial state and different first and second field-changeable stable optical states.

24. The display of claim 23 wherein the light-modulating material comprises polymer-dispersed domains of cholesteric liquid crystal.

25. The method of claim 24 wherein said first field-changeable state is a reflective state and the liquid crystal is essentially in a planar orientation.

26. The method of claim 1 or 2 wherein the electro-optical fluid is selected from the group consisting of a liquid crystal material and an electrophoretic material.

27. The method of claim 26 wherein the electro-optical fluid is a liquid crystal material selected from the group consisting of chiral nematic liquid crystals, nematic liquid crystals, and ferroelectric liquid crystals.

28. The display of claim 23 wherein between the first and the second field-changeable stable optical states, the display is capable of providing a gray scale.

29. The method of claim 1 or 2 wherein the first field-carrying layer comprises conductors that are vacuum deposited or coated.

30. The method of claim 1 or 2 wherein the sheet material has a plurality of display areas, which may be later singulated, each display area capable of displaying a plurality of characters in a background, the characters including a plurality of segments wherein the first field-carrying layer comprises a first patterned conductor layer on the flexible substrate that forms electrically separate areas defining character regions.

31. The method of claim 5 wherein the second field-carrying layer comprises a second patterned conductor layer forming second conductors, and a dielectric layer is deposited over the second patterned conductor layer, the dielectric layer defining holes over each segment or second conductor.

32. The method of claim 31 wherein a third patterned conductor layer or conductive traces is formed over the dielectric layer, the third patterned conductor layer defining a plurality of third conductors connected, through openings in the dielectric layer, to the areas defining the character segments in the second patterned conductor; at least one of the third conductors being connected to a segment in more than one character, whereby a display element is formed that is capable of being addressed in a matrix fashion by electrically addressing the first and the second patterned conductors.

33. The method of claim 32 wherein the display element is connected to a driver capable of addressing the display in a matrix fashion by electrically addressing, via electrical contact with the conductors in the third patterned conductor layer, the first and the second patterned conductor layers.

34. The method of claim 1 or 2 wherein the electro-optical fluid comprises an emulsion having cholesteric liquid crystal material dispersed in a gelatin solution.

35. The method of claim 34 wherein prior to coating, the emulsion is heated to reduce the viscosity of the emulsion and, after coating the heated emulsion in the form of stripes, the temperature of the coated emulsion is lowered to change the state of the coated emulsion from a liquid to a gel state, thereby forming a coating characterized by a corresponding increased-viscosity state; and thereafter drying the coating, while maintaining it in the increased viscosity state, to form a coating in which domains of cholesteric liquid crystals are dispersed in a dried gelatin-containing matrix.

36. The method of claim 35 wherein the gelatin concentration in the emulsion when coated is between 2 and 15 weight percent.

37. The method of claim 36 wherein the domains in the dried coating has an average diameter of 2 to 30 microns.

38. The method of claim 37 wherein the resulting domains are flattened spheres and have on average a thickness at least 50% less than their length.

39. The method of claim 38 wherein the domains have a thickness to length ratio of 1:2 to 1:6.

40. The method of claim 1 or 2 wherein a gel subbing layer is coated between the first field-carrying layer and the electro-optical fluid.

41. The method of claim 2 wherein a gel subbing layer is coated in the vertically stacked layers with the electro-optical layer.

42. The method of claim 2 wherein the vertically stacked layers comprises a second layer of electro-optical material that may be a same or different electro-optical material.

43. The method of claim 1 or 2 wherein a downstream station coats a further layer on the stripes in register therewith.

44. The method of claim 43 wherein another layer comprises a nanopigment material.

45. A method for making a sheet material, useful for displays, comprising the steps of:
(a) providing a flexible substrate;
(b) applying a first field-carrying layer comprising first electrodes over the surface of the flexible substrate;
(c) providing an electro-optical fluid having a plurality of optical states responsive to an electrical field;
(d) coating a plurality of longitudinally spaced-apart substantially parallel stripes, each stripe comprising one or more vertical layers, at least one of which layers comprises the electro-optical fluid, onto the flexible substrate having a field-carrying layer on its surface;
(e) changing the state of the electro-optical fluid from a liquid to a solid-state electro-optical material;
(f) singulating the flexible substrate along its length into a series of panels each having a plurality of parallel stripes each corresponding to a plurality of display elements;
(g) applying a second field-carrying layer comprising second electrodes over parallel stripes in panels; and
(h) singulating the panels into separate display elements.

46. The method of claim 45 each stripe comprising at least two vertically stacked layers, at least one of which layers comprises the electro-optical fluid.

47. The method of claim 45 wherein a dielectric material and conductive traces are applied in sequence over the second field-carrying layer.

48. The method of claim 45 wherein exposed portions of the first electrodes are situated in longitudinal spaces between the substantially parallel stripes.

49. The method of claim 48 wherein conductive contacts for both the first electrodes and the second electrodes are situated in the longitudinal spaces between the substantially parallel stripes.

50. The method of claim 49 wherein conductive contacts are connected to the first electrodes through via holes or other openings in a dielectric layer.

51. The method of claim 49 wherein conductive contacts are connected to the second electrodes through traces over a dielectric layer.

52. The method of claim 1 or 2 wherein suction is applied when coating the substantially parallel stripes.

53. The method of claim 52 wherein the suction is greater than 0.1 inches water gauge (2.5 mm).

54. The method of claim 2 wherein the at least two vertically stacked layers comprises an upper layer and a lower layer, relative to the flexible substrate, and wherein the upper layer has a higher viscosity than the lower layer.

55. The method of claim 54 wherein the viscosity of the upper and lower layers are 20 to 150 Centipoises.

56. The method of claim 2 wherein the top layer has a wet coverage of 1 to 6 cc/ft² (11 to 65 cc/m²).

57. The method of claim 2 wherein the bottom layer has a wet coverage of greater than 38 cc/m² to 76 cc/m².
